(19) United States
(12) Patent Application Publication
(10) Pub. No.: US 2025/0175856 A1
(43) Pub. Date: May 29, 2025

(54) RAN NODE AND METHOD

(71) Applicant: NEC Corporation, Minato-ku, Tokyo (JP)

(72) Inventors: Stanislav FILIN, Tokyo (JP); Sadafuku HAYASHI, Tokyo (JP)

(73) Assignee: NEC Corporation, Minato-ku, Tokyo (JP)

(21) Appl. No.: 18/843,337

(22) PCT Filed: Feb. 7, 2023
(86) PCT No.: PCT/JP2023/003909

§ 371 Date: Sep. 3, 2024

(30) Foreign Application Priority Data
Mar. 8, 2022 (JP) 2022-035279

(51) Int. Cl. H04W 28/086; H04W 24/02

(52) U.S. Cl. CPC H04W 28/0861; H04W 24/02

(57) ABSTRACT

In the RAN node, the control unit is configured to cause the communication unit to transmit the first message toward another RAN node. The first message includes information related to a prediction value for a parameter regarding a load of a first cell of the RAN node.

### TECHNICAL FIELD

The present disclosure relates to a RAN node and method.

### BACKGROUND ART

In the 3rd Generation Partnership Project (3GPP) (registered trademark), there is defined communication between Radio Access Network (RAN) nodes whose cells to be managed are adjacent to each other, such as Handover (HO). For example, Non Patent Literature 1 defines a signaling procedure of a radio network layer of a control plane between Next Generation-Radio Access Network (NG-RAN) nodes in NG-RAN.

### CITATION LIST

### Non Patent Literature

Non Patent Literature 1: 3GPP TS 38.423 V16.7.0 (2021-10), “3rd Generation Partnership Project; Technical Specification Group Radio Access Network; NG-RAN; Xn application protocol (XnAP) (Release 16)”.
Non Patent Literature 2: 3GPP TR 37.816 V16.0.0 (2019-07), “3rd Generation Partnership Project; Technical Specification Group Radio Access Network; Study on RAN-centric data collection and utilization for LTE and NR (Release 16)”.
Non Patent Literature 3: Aurelien Geron, “Hands-On Machine Learning with Scikit-Learn, Keras, and TensorFlow: Concepts, Tools, and Techniques to Build Intelligent Systems 2nd Edition”.
Non Patent Literature 4: Charu C. Aggarwal, “Neural Networks and Deep Learning: A Textbook”.
Non Patent Literature 5: Maxim Lapan, “Deep Reinforcement Learning Hands-On: Apply modern RL methods to practical problems of chatbots, robotics, discrete optimization, web automation, and more, 2nd Edition”.
Non Patent Literature 6: 3GPP TS 38.300 V16.7.0 (2021-09), “3rd Generation Partnership Project; Technical Specification Group Radio Access Network; NR; NR and NG-RAN Overall Description; Stage 2 (Release 16)”.
Non Patent Literature 7: 3GPP TS 23.501 V16.10.0 (2021-09), “3rd Generation Partnership Project; Technical Specification Group Services and System Aspects; System architecture for the 5G System (5GS); Stage 2 (Release 16)”.

### SUMMARY OF INVENTION

### Technical Problem

One of objects of the present disclosure is to provide a RAN node and method that contribute to collecting information useful for the RAN node to provide a cell. Further, the object is merely one of a plurality of objects to be achieved by a plurality of example embodiments disclosed herein. The other objects or problems and novel features will be apparent from the description of the present specification or the accompanying drawings.

### Solution to Problem

A radio access network (RAN) node according to a first aspect, including:
a memory;
a processor coupled to the memory; and
a transceiver, wherein
the processor is configured so as to cause the transceiver to transmit a first message to other RAN nodes, and
the first message includes information related to a prediction value for a parameter regarding a load of a cell of the RAN node.

A radio access network (RAN) node according to a second aspect, including:
a memory;
a processor coupled to the memory; and
a transceiver, wherein
the processor is configured so as to cause the transceiver to receive a first message transmitted from another RAN node, and
the first message includes information about a prediction value for a parameter regarding a load of a cell of the other RAN node.

A method according to a third aspect is a method performed by a radio access network (RAN) node, including transmitting a first message to other RAN nodes,
wherein the first message includes information related to a prediction value for a parameter regarding a load of a cell of the RAN node.

A method according to a fourth aspect is a method performed by a radio access network (RAN) node, including receiving a first message transmitted from another RAN node,
wherein the first message includes information related to a prediction value for a parameter regarding a load of a cell of the other RAN node.

### Advantageous Effects of Invention

According to the present disclosure, it is possible to provide a RAN node and method that contribute to collecting information useful for the RAN node to provide a cell.

### BRIEF DESCRIPTION OF DRAWINGS

FIG. 1 is a diagram for illustrating an example of configuration of a communication system according to a first example embodiment.

FIG. 2 is a diagram for illustrating an example of configuration of a RAN node.

FIG. 3 is a diagram for illustrating an example of operations of the communication system according to the first example embodiment.

FIG. 4 is a diagram for illustrating an example of operations of a communication system according to a second example embodiment.

FIG. 5 is a diagram for illustrating an example of configuration of a communication system according to a third example embodiment.

FIG. 6 is a diagram for illustrating an example of operations of the communication system according to a third example embodiment.

FIG. 7A is a diagram for explaining an example of time-series data of information related to a prediction value for a load parameter.

FIG. 7B is a diagram for explaining another example of time-series data of information related to a prediction value for a load parameter.

FIG. 8 is a diagram for illustrating a Resource Status Reporting Initiation procedure.

FIG. 9 is a diagram for illustrating another example of time-series data of information related to a prediction value for a load parameter.

FIG. 10 is a diagram for illustrating a procedure of Resource Status Reporting.

FIG. 11 is a diagram for illustrating PREDICTIONS Reporting Initiation procedure.

FIG. 12 is a diagram for illustrating a procedure of PREDICTIONS Reporting.

FIG. 13 is a diagram for illustrating an example of configuration of a hardware of a RAN node.

FIG. 14A is a diagram for illustrating an example of configuration of a RESOURCE STATUS REQUEST message.

FIG. 14B is a diagram for illustrating the example of configuration of the RESOURCE STATUS REQUEST message (continuation of FIG. 14A).

FIG. 14C is a diagram for illustrating the example of configuration of the RESOURCE STATUS REQUEST message (continuation of FIG. 14B).

FIG. 15 is a diagram for illustrating an example of configuration of a RESOURCE STATUS UPDATE message.

FIG. 16A is a diagram for illustrating an example of configuration of Radio Resource Status IE.

FIG. 16B is a diagram for illustrating the example of configuration of the Radio Resource Status IE (continuation of FIG. 16A).

FIG. 16C is a diagram for illustrating the example of configuration of the Radio Resource Status IE (continuation of FIG. 16B).

FIG. 16D is a diagram for illustrating the example of configuration of the Radio Resource Status IE (continuation of FIG. 16C).

FIG. 16E is a diagram for illustrating the example of configuration of the Radio Resource Status IE (continuation of FIG. 16D).

FIG. 17 is a diagram for illustrating an example of configuration of Composite Available Capacity Group IE.

FIG. 18 is a diagram for illustrating an example of configuration of Composite Available Capacity IE.

FIG. 19 is a diagram for illustrating an example of configuration of Cell Capacity Class Value IE.

FIG. 20 is a diagram for illustrating an example of configuration of Capacity Value IE.

FIG. 21 is a diagram for illustrating an example of configuration of Slice Available Capacity IE.

FIG. 22A is a diagram for illustrating an example of configuration of PREDICTIONS REQUEST message.

FIG. 22B is a diagram for illustrating the example of configuration of the PREDICTIONS REQUEST message (continuation of FIG. 22A).

FIG. 23 is a diagram for illustrating an example of configuration of PREDICTIONS RESPONSE message.

FIG. 24 is a diagram for illustrating an example of configuration of PREDICTIONS UPDATE message.

FIG. 25A is a diagram for illustrating an example of configuration of Radio Resource Load Predictions IE.

FIG. 25B is a diagram for illustrating the example of configuration of the Radio Resource Load Predictions IE (continuation of FIG. 25A).

FIG. 26 is a diagram for illustrating an example of configuration of a Load prediction type.

FIG. 27 is a diagram for illustrating an example of configuration of Prediction time series.

### EXAMPLE EMBODIMENT

Hereinafter, example embodiments of the present disclosure will be described with reference to the diagrams. Further, the following description and drawings are appropriately omitted and simplified for clarity of explanation. Also, in each of the following diagrams, the same elements are denoted by the same reference numerals, and repeated descriptions thereof will be omitted as necessary. Also, in the present disclosure, unless otherwise specified, “at least one of A or B (A/B)” may mean any one of A and B or may mean both A and B. Similarly, in a case where “at least one of” is used for three or more elements, this may mean any one of these elements or may mean any number of a plurality of elements (including all elements).

### First Example Embodiment

### <Example of Configuration of Communication System>

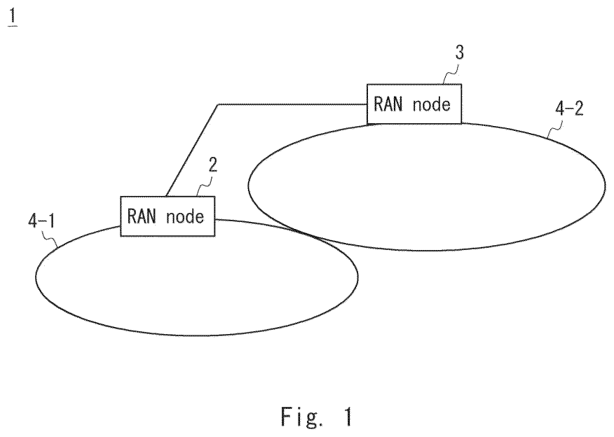

FIG. 1 is a diagram for illustrating an example of configuration of a communication system according to a first example embodiment. The communication system 1 is, for example, a fifth generation mobile communication system (5G system). The 5G system adopts New Radio Access (NR) which is the fifth generation radio access technology. Further, the communication system 1 is not limited to the fifth generation mobile communication system, but may be a different mobile communication system such as a Long Term Evolution (LTE) system, an LTE-Advanced system, or a sixth generation mobile communication system. Also, the communication system 1 may be another radio communication system including at least a Radio Access Network (RAN) node and User Equipment (UE). The communication system 1 may be a communication system in which ng-eNB (LTE evolved NodeB) as a base station in Long Term Evolution (LTE) connects to a 5G Core network (5GC) through an NG interface.

The communication system 1 includes a RAN node 2 and a RAN node 3. Further, although only two RAN nodes are illustrated in FIG. 1, the communication system 1 may include three or more RAN nodes.

The RAN node 2 and the RAN node 3 may be gNBs. The gNB is a node that terminates protocols of the NR user plane and the control plane for the UE and is connected to the 5GC through the NG interface. The RAN node 2 and the RAN node 3 may be ng-eNBs. The ng-eNB is a node that terminates an Evolved Universal Terrestrial Radio Access (E-UTRA) user plane and control plane protocols for the UE and connects to the 5GC through an NG interface. The RAN node 2 and the RAN node 3 may be a Central Unit (CU) in a Cloud RAN (C-RAN) configuration or may be a gNB-CU. The gNB-CU is a logical node that hosts a Radio Resource Control (RRC) protocol, a Service Data Adaptation Protocol (SDAP) protocol, and a Packet Data Convergence Protocol (PDCP) protocol of the gNB. Alternatively, the gNB-CU is a logical node that hosts the RRC protocol and the PDCP protocol of the en-gNB for controlling operations of one or more of gNB-Distributed Units (gNB-DUs). The gNB-CU terminates an F1 interface connected to the gNB-DU. The RAN node 2 and the RAN node 3 may be a Control Plane (CP) Unit or a gNB-CU-Control Plane (gNB-CU-CP). The gNB-CU-CP is a logical node that hosts a control plane part of the RRC protocol and the PDCP protocol of the gNB-CU for the en-gNB or the gNB. The gNB-CU-CP terminates an E1 interface connected to the gNB-CU-User Plane (gNB-CU-UP) and an F1-C interface connected to the gNB-DU. The gNB-CU-UP is a logical node that hosts a user plane part of the PDCP protocol of the gNB-CU for the en-gNB. The gNB-CU-UP terminates an E1 interface connected to the gNB-CU-CP and an F1-U interface connected to the gNB-DU.

Further, the RAN node 2 and the RAN node 3 may be an eNB or an eNB-CU. Also, the RAN node 2 and the RAN node 3 may be an EUTRAN (Evolved Universal Mobile Telecommunications System (UMTS) Terrestrial Radio Access Network) node or an NG-RAN (Next Generation Radio Access Network) node. The EUTRAN node may be an eNB or en-gNB. The NG-RAN node may be a gNB or an ng-eNB. The en-gNB provides protocol terminations of the NR user plane and the control plane for the UE, and operates as a secondary node in an NR Dual Connectivity (EN-DC).

The RAN node 2 and the RAN node 3 establish an inter-node interface and communicate with each other through the inter-node interface. The inter-node interface may be an Xn interface (network interface between NG-RAN nodes), may be an X2 interface, or may be another inter-node interface.

Also, in FIG. 1, the RAN node 2 provides (serves) at least one cell 4-1 (a first cell). The RAN node 2 operates the cell 4-1, and connects to and communicates with the UE in the cell 4-1. The RAN node 3 provides at least one cell 4-2 (a second cell). The RAN node 3 operates the cell 4-2, and connects to and communicates with the UE in the cell 4-2. Here, the cells 4-1 and 4-2 are adjacent to each other. The fact that the cell 4-1 is adjacent to the cell 4-2 may indicate a status in which the cells 4-1 and 4-2 are in contact with each other, or may indicate a status in which a part of the cell 4-1 overlaps the cell 4-2.

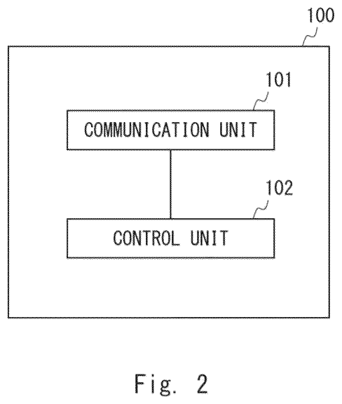

FIG. 2 is a diagram for illustrating an example of configuration of a RAN node. In FIG. 2, the RAN node 2 and the RAN node 3 are collectively referred to as a RAN node 100. The RAN node 100 includes a communication unit 101 and a control unit 102. The communication unit 101 and the control unit 102 may be software components or modules of which the processing is performed by causing a processor to execute a program stored in a memory. Also, the communication unit 101 and the control unit 102 may be hardware components such as circuits or chips.

The communication unit 101 connects to and communicates with other RAN nodes and core network nodes that are included in the access network. Also, the communication unit 101 also connects to the UE and communicates therewith. More specifically, the communication unit 101 receives various types of information from other RAN nodes, core network nodes, and UEs. Also, the communication unit 101 transmits various types of information to other RAN nodes, core network nodes, and UEs.

The control unit 102 executes various processes of the RAN node 100 by reading and executing various kinds of information and programs stored in the memory. The control unit 102 performs processing according to any or all setting information such as various information elements (IEs), various fields, and various conditions included in the message received by the communication unit 101. The control unit 102 is configured to be able to execute processes of a plurality of layers. The plurality of layers may include a Physical layer, a Media Access Control (MAC) layer, a Radio Link Control (RLC) layer, a PDCP layer, an RRC layer, a Non Access Stratum (NAS) layer, and the like.

The example of configuration of the communication system described above is common to the first example embodiment and the second example embodiment. Also, RAN nodes 2A and 2B in the first example embodiment and the second example embodiment are collectively referred to as the RAN node 2, and RAN nodes 3A and 3B in the first example embodiment and the second example embodiment are collectively referred to as the RAN node 3. In the first example embodiment and the second example embodiment, different operations performed respectively by different RAN nodes will be described.

### <Examples of Operations of Communication System>

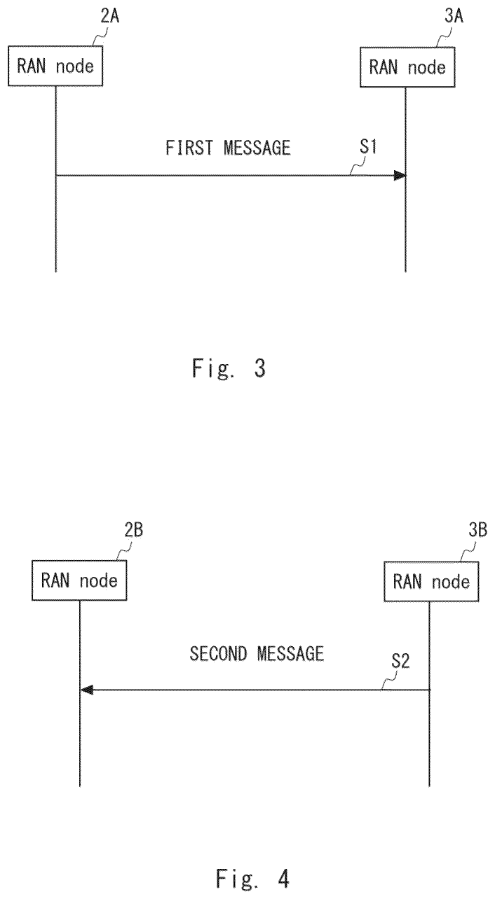

FIG. 3 is a diagram for illustrating an example of operations of the communication system according to a first example embodiment. Hereinafter, an example of operations of a communication system 1 will be described with reference to FIG. 3.

In step S1, the RAN node 2A transmits a first message to the RAN node 3A. The first message includes information related to a prediction value for a parameter regarding a load of cell 4-1. The “parameter regarding a load” is a parameter that may be an indicator regarding the load of the cell 4-1. The “prediction value for the parameter regarding the load” means a value for the parameter regarding the load, that is not an actual measurement value. The “information related to the prediction value” may include a prediction value at each of a plurality of timings. For example, the “prediction value for the parameter regarding the load” may include a prediction value for the parameter regarding the load at the timing of a prediction execution time point, a prediction value for the parameter regarding the load at a timing after the timing, or both of them. Further, hereinafter, the “parameter regarding the load” may be referred to as a “load parameter”.

Also, for example, the “information related to the prediction value” may include a prediction value and prediction accuracy of the prediction value. Also, for example, the “information related to the prediction value” may include a prediction value under assumption that the number of active user equipments (UEs) in a domain related to the load parameter of the cell (for example, a cell, a beam, a slice, or any combination thereof) is unchanged during a prediction period, a prediction value under consideration that the number of active UEs in the domain related to the load parameter of the cell is changed during the prediction period, or both of these prediction values.

Then, the RAN node 3A receives the first message transmitted from the RAN node 2A. Further, as will be described in detail below, the first message is not particularly limited, but may be, for example, a Resource Status Update message of a Resource Status Reporting procedure or a message of a new procedure (for example, Predictions Update message of Predictions reporting procedure).

As described above, according to the first example embodiment, the RAN node 2A transmits the first message to the RAN node 3A. The first message includes information related to a prediction value for the load parameter of the cell 4-1. Accordingly, the RAN node 3A may acquire information about the load parameter at a timing closer to the timing to be used for processing than the timing of the actual measurement value. As a result, the accuracy of the processing of the RAN node 3A may be improved. That is, the RAN node 2A contributes to collecting information useful for the RAN node 3A to provide a cell.

### Second Example Embodiment

FIG. 4 is a diagram for illustrating an example of operations of a communication system according to a second example embodiment. Hereinafter, an example of operations of a communication system 1 according to a second example embodiment will be described with reference to FIG. 4.

In step S2, the RAN node 3B transmits a second message to the RAN node 2B. The second message includes, for example, information about a transmission request for information related to the prediction value (report request for information related to the prediction value). Hereinafter, the “transmission request for information related to a prediction value” may be simply referred to as a “transmission request for a prediction value”. For example, the “transmission request for the prediction value” may be performed for each combination of a load parameter and a prediction type. For example, a bit region may be prepared for each of any combination of the load parameter and the prediction type in the second message, and it may be indicated that the prediction value of the combination corresponding to the bit region is requested or the prediction value of the combination corresponding to the bit region is not requested according to the bit value included in the bit region. For example, in a case where the bit value of the bit region=“1”, the prediction value of the combination corresponding to the bit region is requested. On the other hand, in a case where the bit value of the bit region=“0”, the prediction value of the combination corresponding to the bit region is not requested.

Also, for example, the second message may include information about a reporting period of the prediction value. The “reporting period of the prediction value” means, for example, a time interval between transmission timings of two first messages including the prediction value in a case where the prediction value is included in the first message and repeatedly transmitted.

Also, for example, the second message may include information about the prediction granularity related to a timing interval of the prediction value. In a case where a plurality of prediction values are included in the first message, the “prediction granularity” means a time interval between timings corresponding respectively to two prediction values.

Then, the RAN node 2B receives the second message transmitted from the RAN node 3B. Then, in response to the transmission request for the prediction value of the second message, the RAN node 2B transmits, to the RAN node 3B, a first message including information related to the prediction value for the load parameter of the cell 4-1. Further, as will be described in detail below, the second message is not particularly limited, but may be, for example, a RESOURCE STATUS REQUEST message defined in section 9.1.3.18 of Non Patent Literature 1, or a message of a new procedure (for example, Predictions Request message of Predictions reporting initiation procedure).

As described above, according to the second example embodiment, the RAN node 3B transmits the second message to the RAN node 3A. The second message includes information about the transmission request for the prediction value. Therefore, the RAN node 3B may cause the RAN node 3A to transmit information related to the load parameter at a timing closer to the timing to be used for processing than the timing of the actual measurement value. Accordingly, the RAN node 3B may acquire information related to the load parameter at a timing closer to the timing to be used for processing than the timing of the actual measurement value. As a result, the accuracy of the processing of the RAN node 3B may be improved. That is, the RAN node 2B and the RAN node 3B contribute to collecting information useful for the RAN node 3B to provide a cell.

### Third Example Embodiment

In the third example embodiment, a specific example of the communication system described in the first example embodiment and the second example embodiment will be described.

### <Example of Configuration of Communication System>

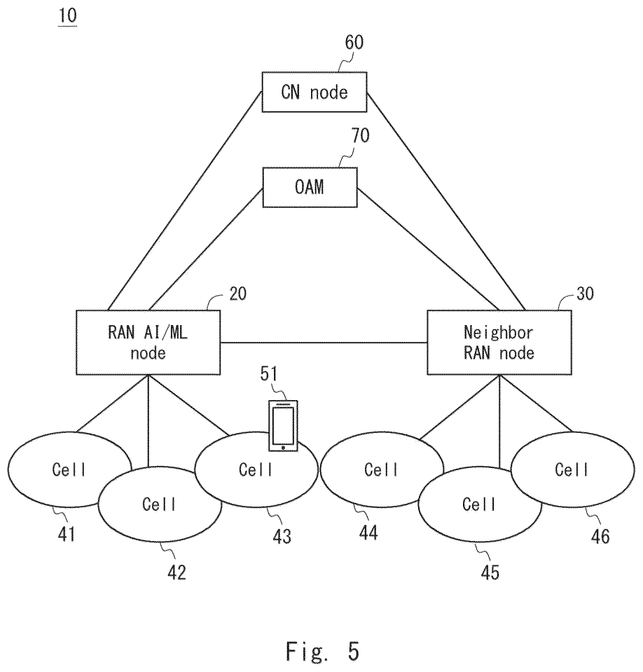

FIG. 5 is a diagram for illustrating an example of configuration of a communication system according to a third example embodiment. The communication system 10 is, for example, a 5G system, and includes a RAN node 20 and a RAN node 30 which are a gNB or a gNB-CU.

In FIG. 5, the RAN node 20 provides cells 41 to 43. Specifically, the RAN node 20 operates cells 41 to 43, and connects to and communicates with UEs in cells 41 to 43. In this example, the RAN node 20 is connected to UE 51 in cell 43. Also, in FIG. 5, the RAN node 30 provides cells 44 to 46. Specifically, the RAN node 30 operates cells 44 to 46, and connects to and communicates with UEs in cells 44 to 46. The RAN node 20 and the RAN node 30 establish an inter-node Xn interface and communicate with each other through the inter-node interface. Further, here, in order to simplify the description, it has been described that each of the RAN node 20 and the RAN node 30 operates three cells, but the number of cells operated by each of the RAN node 20 and the RAN node 30 is not limited thereto.

In FIG. 5, the cell 43 provided by RAN node 20 is adjacent to the cell 44 provided by the RAN node 30. Hereinafter, the cell 43 and the cell 44 may be referred to as “neighbor cells”. Here, the “neighbor cells” refer to two or more cells having at least partially overlapping coverage areas. Similarly, two or more RAN nodes having neighbor cells are referred to as “adjacent RAN nodes”. For example, the RAN nodes 20 and 30 are adjacent RAN nodes. On the other hand, the cells 41 and 42 of the RAN node 20 are not adjacent to any cell of the RAN node 30. Also, the cells 45 and 46 of the RAN node 30 are not adjacent to any cell of the RAN node 20. Therefore, hereinafter, the cells 41 and 42 may be referred to as “internal cells” of the RAN node 20, and the cells 45 and 46 may be referred to as “internal cells” of the RAN node 30.

Also, the RAN node 20 is an AI-compatible RAN node (RAN AI/ML node). The RAN node 20 may be referred to as a RAN node equipped with an AI function or may be referred to as a RAN node including an AI function. In the third example embodiment, the RAN node 20 is referred to as an AI-enhanced RAN node. The RAN node 20 has an AI function that performs communication control based on information received from other apparatuses (other network elements) including UEs such as the UE 51 and the RAN node 30, and includes Machine Learning (ML) as an example of the AI function in the third example embodiment. In this example, the AI/ML function executes a process of “predicting a value related to a parameter regarding a load”, but processes to be executed are not limited thereto.

In the present disclosure, “an AI-compatible RAN node”, “a RAN node equipped with an AI function”, and “a RAN node including an AI function” refer to a RAN node that uses an AI/ML model for performing communication control based on information received from another apparatus (another network element). For example, the RAN node 20 may communicate with a RAN intelligence apparatus (not illustrated) and operate as a RAN node equipped with an AI function by using an AI/ML model held by the RAN intelligence apparatus. Alternatively, the RAN node 20 may include a function of the RAN intelligence apparatus and operate as a RAN node equipped with the AI function by using the AI/ML model held by the RAN intelligence apparatus. Alternatively, the RAN node 20 may acquire the AI/ML model from the RAN intelligence apparatus and operate as a RAN node equipped with the AI function by using the AI/ML model by the RAN node 20.

The RAN intelligence apparatus is, for example, control apparatus responsible for making the RAN intelligent, and is control apparatus that performs communication control of the RAN. The RAN intelligence apparatus may be, for example, a RAN Intelligent Controller (RIC) defined by an Open RAN (O-RAN). The RAN intelligence apparatus performs policy management, analysis of various types of information of the RAN, AI-based function management, load distribution for each UE, management of radio resources, Quality of Service (QOS) management, and mobility management such as handover control.

The example of configuration of the RAN nodes 20 and 30 is as illustrated in FIG. 2. Here, in a case where the RAN node 100 operates as the RAN node 20 and the RAN intelligence apparatus is provided outside the RAN node 20, the communication unit 101 is connected to the RAN intelligence apparatus and performs communication. In this case, the communication unit 101 may communicate with the RAN intelligence apparatus, and the control unit 102 may use the AI/ML model held by the RAN intelligence apparatus. Alternatively, the communication unit 101 may communicate with the RAN intelligence apparatus and acquire the AI/ML model held by the RAN intelligence apparatus.

In a case where the RAN node 100 is the RAN node 20, the control unit 102 may perform the communication control of the RAN based on information received by the communication unit 101 using the AI/ML model. Specifically, the control unit 102 may input information received by the communication unit 101 to the AI/ML model, and cause the AI/ML model to output various types of information related to the communication control of the RAN and/or various types of information related to the communication control of the UE. The control unit 102 may control the RAN and the UE by transmitting such various information to the RAN node and the UE. The control unit 102 may perform machine learning on the AI/ML model based on information received by the communication unit 101. Further, “learning”, and “training” in the present disclosure have meanings of automatically adjusting parameters of an AI/ML model and constructing the AI/ML model.

In the third example embodiment, there is provided a deployment scenario in which an AI function in the RAN node serves only one gNB or gNB-CU, thereby providing a fully distributed autonomous solution. However, the AI function in the RAN node may provide services to a plurality of gNBs or gNB-CUs.

Also, in this example, a core network (CN) node 60 in FIG. 5 has a Network Data Analytic Function (NWDAF). A CN node 60 has a function of collecting and analyzing various data acquired in the network of the 5GC. Also, the Operations, Administration and Management (OAM) apparatus 70 has an operation management function of the communication system 10.

### <Examples of Operations of Communication System>

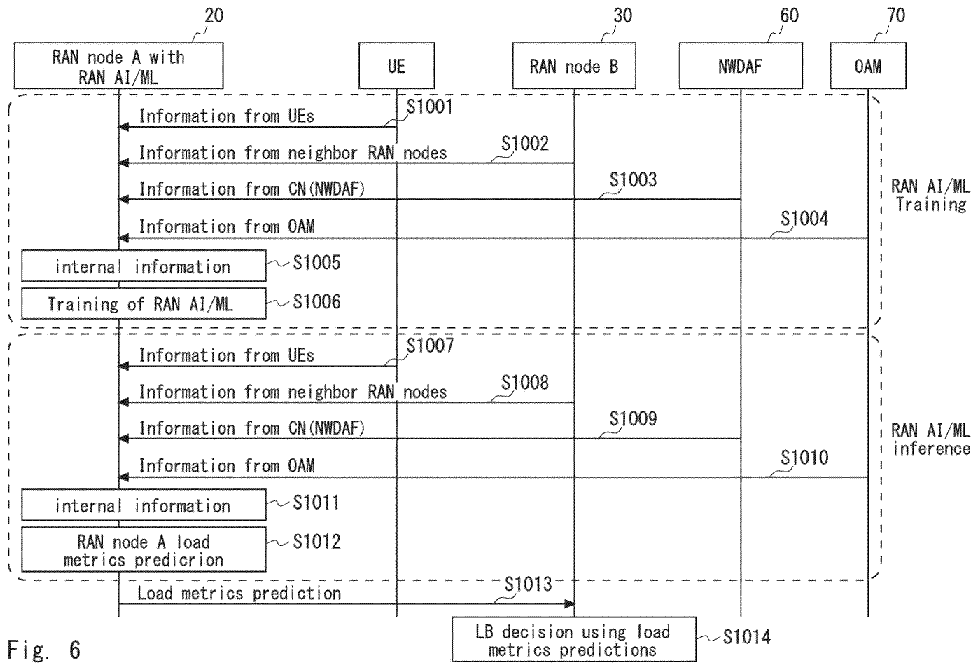

FIG. 6 is a diagram for illustrating an example of operations of the communication system according to the third example embodiment. Hereinafter, an outline of processing to be performed by the communication system 10 will be described with reference to FIG. 6. Further, in the present example embodiment, it is assumed that the RAN node 20 is aware of adjacent RAN node 30, and the RAN node 20, the RAN node 30, the CN node 60, and the OAM apparatus 70 establish an inter-node interface with one another. Further, the order of the following each step is not limited unless otherwise specified. Also, the presence or absence of each step or the presence or absence of detailed processing of each step may be appropriately changed.

### (Step S1001)

The RAN node 20 acquires various types of information from a UE (for example, the UE 51) located in a cell provided by the RAN node 20.

Information acquired from the UE (for example, the UE 51) includes, for example, a part or all of following information.
Information about UE location (UE location information)
Information about the quality of service required for the UE (UE QOS requirements)
Information about UE traffic (UE traffic information): for example, an average traffic rate or more detailed information for traffic (information for the next packet arrival, or the like).
Information about UE radio measurements (UE radio measurements): for example, quality information measured for a serving cell in which the UE is present (resides in), a cell adjacent to the serving cell, or both of these cells. The quality information may include at least one of RSRP, RSRQ, and SINR.
Information about inactive UEs (Information about inactive UEs)

### (Step S1002)

The RAN node 20 acquires various types of information from the adjacent RAN node 30.

The “information acquired from the adjacent RAN node 30” includes, for example, a part or all of the following information.
Information regarding the load of the adjacent RAN node 30 (load information (also referred to as load metrics)): information regarding the load may be information indicating traffic or Information about traffic. Also, information regarding the load may indicate a bit rate or may be information about the bit rate. For example, information regarding the load may be information indicating a Guaranteed Bit Rate (GBR) or a non-GBR of at least one of Downlink/Uplink (DL/UL). Also, information regarding the load may be information indicating resource block usage, or may be information about usage. For example, information regarding the load may be information indicating total Physical Resource Block (PRB) usage. As a specific example, information regarding the load may be information indicating at least one of the following.

At least one of Guaranteed Bit Rate (GBR), non-GBR, or total Physical Resource Block (PRB) usage of at least one of Downlink/Uplink (DL/UL) in at least one of each cell or each beam provided by the RAN node 30

At least one of GBR, non-GBR, or total PRB usage of at least one of DL/UL per slice in each cell

Also, information regarding the load may include individual load information in at least one of Normal UL/Supplementary UL (NUL/SUL).
Information about the handover performance with the RAN node 30 (Information related to HO performance with this RAN node): this is Information about performance regarding a handover between the cell of the RAN node 20 and the cell of the adjacent RAN node 30.
Information about the UE moving toward the RAN node 20 (Information about UEs moving forward this RAN node): this is information about the UE located in the cell of the adjacent RAN node 30 and moving towards the RAN node 20.

Further, in a case where the RAN node 30 is also an AI-compatible RAN node, information acquired from the adjacent RAN node 30 may include “information related to a prediction value for a load parameter of a cell of the adjacent RAN node 30”.

Further, the “slice” in the present disclosure is a network slice provided by a core network (e.g., 5GC) as defined in section 16.3.1 of Non Patent Literature 6, for example. Specifically, network slicing may be implemented in NR connected to 5GC and NG-RAN of E-UTRA connected to 5GC. The slice is composed of a RAN part and a CN part, and slice support is based on a principle that traffic of different slices is processed by different PDU sessions. The network may implement different slices by providing scheduling and different L1/L2 settings.

Each slice is uniquely identified by Single Network Slice Selection Assistance information (S-NSSAI) as defined in Non Patent Literature 7. The Network Slice Selection Assistance Information (NSSAI) includes one or more pieces of S-NSSAI, and the S-NSSAI is a combination of the following.
A mandatory Slice/Service Type (SST) field that identifies a type of slice and is composed of 8 bits (the range of 0 to 255)
Optional Slice Differentiator (SD) field that distinguishes slices having the same SST field and is composed of 24 bits

This list includes up to eight S-NSSAI. In a case where the NSSAI for slice selection is provided from NAS, the UE provides the NSSAI in RRCSetupComplete. Although the network may support a large number (hundreds) of slices, the UE does not need to simultaneously support more than 8 slices. Bandwidth reduced Low complexity (BL) UE or Narrow Band Internet of Things (NB-IoT) UE simultaneously support up to eight slices.

For example, the slice is notified from the core network (e.g., 5GC) to the NAS layer of the UE and is notified from the NAS layer of the UE to the AS layer (e.g., RRC). The network slices selected and intended by the UE may be referred to as selected NSSAI and intended NSSAI, respectively. The selected network slice (selected NSSAI) may be referred to as allowed NSSAI in meaning of a network slice allowed to be used by the core network. The SST may be included in the S-NSSAI (that is, the S-NSSAI may include information of the SST).

Each of the network slices selected or intended by the UE may be specified by S-NSSAI that is an identifier. The selected or intended network slice may be S-NSSAI(s) included in the configured NSSAI or S-NSSAI(s) included in the allowed NSSAI. Further, S-NSSAIs within the Requested NSSAI included in the NAS registration request message need to be a part of the configured NSSAI and/or the allowed NSSAI. Therefore, the intended network slice may be S-NSSAI(s) included in the Requested NSSAI.

Such network slicing allows multiple virtualized logical networks to be generated on top of the physical network using Network Function Virtualization (NFV) and software-defined networking (SDN) techniques. Each virtualized logical network is referred to as a network slice or network slice instance, includes logical nodes and functions, and is used for specific traffic and signaling. The NG RAN, the NG Core, or both of them have a Slice Selection Function (SSF). The SSF selects one or more of network slices suitable for the NG UE based on information provided by at least one of the NG UE and the NG Core.

For example, a plurality of slices are distinguished by the services or use cases provided to the UEs on respective network slices. For example, use cases include enhanced Mobile Broad Band (eMBB), Ultra Reliable and Low Latency Communications (URLLC), and massive Machine Type Communication (mMTC). These are referred to as slice types (e.g., Slice/Service Type (SST)). The RAN node for providing the communication to the UE may assign, to the UE, a RAN slice and a radio slice associated with the network slice of the core network selected for the UE in order to provide the UE with end-to-end network slicing.

### (Step S1003)

The RAN node 20 acquires network information from the CN node 60 (NWDAF).

The acquisition of the network information may be implemented, for example, through an existing NWDAF subscription service. The network information transmitted from the CN node 60 may include, for example, a Network function load, a slice load, and a service experience. The network information may include Network performance. Also, the network information may include UE mobility. Here, the network performance may include statistics or prediction of a status of a RAN node such as a gNB, resource usage, communication and mobility performance, the number of UEs in an area of interest, and an average ratio of successful handover. Also, the UE mobility may be time-series of statistics or predictions of the location of a specific UE or a group of UEs. However, the RAN node 20 may acquire such network information from apparatus on the 5GC that is not limited to the CN node 60.

### (Step S1004)

Since the RAN node 20 is an AI-enhanced RAN node, the RAN node 20 acquires network information from the OAM apparatus 70.

The network information transmitted from the OAM apparatus 70 may include area information, traffic information, and statistics information, for example, of a cell in which the UE is present. The statistics information may include statistics information regarding handover and statistics information regarding call processing such as call connection and call disconnection. Further, step S1004 may be performed before step S1003, may be performed after step S1003, or may be performed simultaneously with step S1003.

In this manner, the RAN node 20 may receive the network information from the CN node 60 and the OAM apparatus 70. Therefore, by the system including the RAN node 20, the CN node 60, and the OAM apparatus 70, the AI-compatible RAN node 20 contributes to transmitting and receiving information to and from the CN node 60 and the OAM apparatus 70. Also, the RAN node 20 may further optimize the communication control of the RAN using the AI function included in the RAN node 20 based on the network information.

### (Step S1005)

The RAN node 20 acquires internal information about the RAN node 20 itself.

The “internal information” may include time-series of information regarding a load measured (generated) in the past. Also, the “internal information” may include information about the distribution of the UEs among slices, cells, or beams of the RAN node 20, or any combination thereof. Also, the “internal information” may include information about operation of the load balancing algorithm applied to among slices, cells, or beams of the RAN nodes 20, or any combination thereof.

### (Step S1006)

The RAN node 20 performs initial or periodic training of the AI/ML model held by the RAN intelligence apparatus or the AI/ML model acquired from the RAN intelligence apparatus based on various types of information (for example, measurement values) acquired in steps S1001 to S1005. The AI/ML model is a machine learning (ML) model which information acquired in steps S1001 to S1005 is input to and the communication control of the RAN is performed in. In the present example embodiment, the AI/ML model is an ML model which information acquired in steps S1001 to S1005 is input to and at least “information related to the prediction value for the load parameter is output from”. In a case where information is acquired at the first time in steps S1001 to S1005, the RAN node 20 performs initial training of the AI/ML model. Also, every time the RAN node 20 acquires information in steps S1001 to S1005, the RAN node 20 periodically performs training and updating the AI/ML model. Accordingly, the AI/ML is sufficiently trained. Also, for example, the RAN node 20 may pass, to training apparatus, information acquired in steps S1001 to S1005 for updating the AI/ML model. Further, the AI/ML model used in this disclosure may be a new model or a known ML model (for example, as described in Non Patent Literatures 3 to 5).

### (Step S1007 to S1011)

In steps S1007 to S1011, the RAN node 20 acquires various types of information as in steps S1001 to S1005.

### (Step S1012)

In a case where the AI/ML is sufficiently trained, the RAN node 20 generates “information related to the prediction value for the load parameter of the cell of the RAN node 20” using information acquired in S1007 to S1011.

The “load parameter of the cell” may include, for example, at least one of the following.
For requested cells, beams, and slices:
At least one of Guaranteed Bit Rate (GBR), non-GBR, or total Physical Resource Block (PRB) usage of at least one of Downlink/Uplink (DL/UL) for each beam of each cell provided by the RAN node 20
At least one of Guaranteed Bit Rate (GBR), non-GBR, or total Physical Resource Block (PRB) usage of at least one of Downlink/Uplink (DL/UL) for each slice of each cell provided by the RAN node 20
For requested cells and beams:

The DL, UL, or Supplementary UL (SUL) capacity including at least one of a capacity of each cell (Per cell capacity) or a capacity for each beam of each cell (Per cell per beam capacity) provided by the RAN node 20.
For requested cells and slices:

Capacity of at least one of Downlink/Uplink (DL/UL) for each beam of each cell provided by the RAN node 20

Also, the prediction of each parameter regarding the load of the cell may include the following “prediction type”.
“Prediction for fixed number of UEs (Predictions for fixed number of UEs)”
Average load prediction
Minimum load prediction and maximum load prediction (Minimum and maximum load prediction)
“Prediction for changing number of UEs (Predictions for changing number of UEs)”
Average load prediction
Minimum load prediction and maximum load prediction (Minimum and maximum load prediction)

That is, each of any combination of the prediction for fixed number of UEs, the prediction for changing number of UEs, an item (average load prediction, minimum load prediction, and maximum load prediction) included in the prediction for fixed number of UEs, and an item (average load prediction, minimum load prediction, and maximum load prediction) included in the prediction for changing number of UEs may be one of “prediction types”.

For example, there may be the following prediction types. Here, five examples are given, but the present disclosure is not limited thereto.
“Prediction type 1 (prediction type 1)”=“Prediction for fixed number of UEs: average load prediction”
“Prediction type 2”=“Prediction for fixed number of UEs: average load prediction, minimum load prediction, maximum load prediction”
“Prediction type 3”=“Prediction for fixed number of UEs: minimum load prediction, maximum load prediction”
“Prediction type 4”=“Prediction for fixed number of UEs: average load prediction”+“Prediction for a changing number of UEs: average load prediction”
“Prediction type 5”=“Prediction for fixed number of UEs: average load prediction, minimum load prediction, maximum load prediction”+“Prediction for changing number of UEs: average load prediction, minimum load prediction, maximum load prediction”

Here, the “Prediction for fixed number of UEs (Predictions for fixed number of UEs)” are predictions under assumption that the number of active user equipments (UEs) in the domain (for example, a cell, a beam, a slice, or any combination thereof) related to the load parameter is unchanged during the prediction period.

Also, the “Prediction for changing number of UEs (Predictions for changing number of UEs)” are predictions under consideration that the number of active UEs in the domain (for example, a cell, a beam, a slice, or any combination thereof) related to the load parameter is changed during the prediction period.

Also, the “average load prediction” is a prediction regarding an average value of loads based on current measured load values measured for a cell of interest.

Also, the “minimum load prediction” is prediction regarding a minimum value of the load based on the measured load values (current measured load values) of a cell of interest and an internal cell adjacent to the cell of interest (for example, an internal cell 42 adjacent to the cell 43) under assumption that traffic is offloaded from the cell of interest to the internal cell.

Also, the “maximum load prediction” is prediction regarding a maximum value of the load based on measured load values (current measured load values) of a cell of interest and an internal cell adjacent to the cell of interest (for example, an internal cell 42 adjacent to the cell 43) under assumption that traffic is offloaded from the internal cell to the cell of interest.

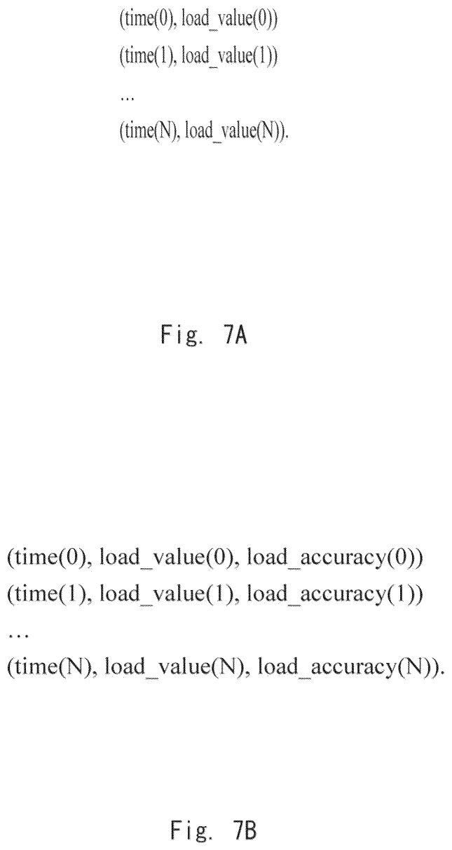

Also, the “information related to the prediction value for the load parameter” may be represented as time-series. FIG. 7A is a diagram for explaining an example of time-series data of information related to a prediction value for a load parameter. In the example illustrated in FIG. 7A, the time-series data of “information related to the prediction value” includes a plurality of data sets. In FIG. 7A, one of data sets is represented as a portion enclosed in parentheses. Each of data sets includes timing information (time (N)) and a prediction value (load_value (N)).

FIG. 7B is a diagram for explaining another example of time-series data of information related to a prediction value for a load parameter. In the example illustrated in FIG. 7B, the time-series data of “information related to the prediction value” includes a plurality of data sets. In FIG. 7B, one of data sets is represented as a portion enclosed in parentheses. Each of data sets includes timing information (time (N)), a prediction value (load_value (N)), and prediction accuracy (load_accuracy (N)).

Also, the time-series data of the “information related to the prediction value” may include a plurality of data sets according to a predetermined “prediction granularity”. The “prediction granularity” corresponds to a timing interval of the prediction value. That is, in the examples of FIGS. 7A and 7B, the “prediction granularity” corresponds to “time (N)−time (N−1)”.

### (Step S1013)

The RAN node 20 transmits a first message including the generated “information related to the prediction value for the load parameter of the cell” to the RAN node 30.

The first message may be, for example, a Resource Status Update message of a Resource Status Reporting procedure or a message of a new procedure (for example, Predictions Update message of Predictions reporting procedure).

### (A) Use of Resource Status Reporting Procedure

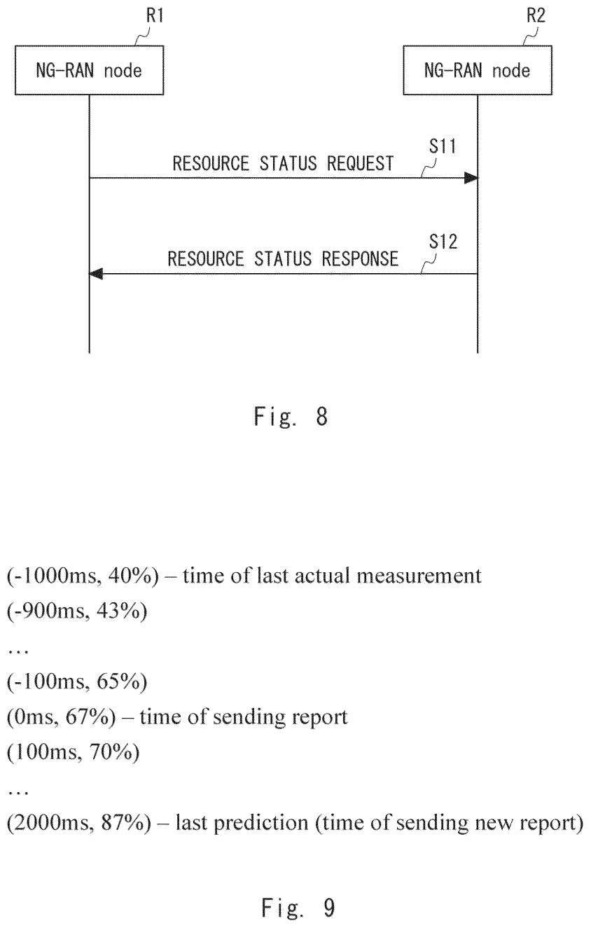

FIG. 8 illustrates a Resource Status Reporting Initiation procedure used to request other NG-RAN nodes to report load measurements. This procedure may be used to transmit the second message described in the second example embodiment. In step S11 of FIG. 8, the NG-RAN node R1 transmits a RESOURCE STATUS REQUEST message to the NG-RAN node R2. The NG-RAN node R1 corresponds to the foregoing RAN node 30, and the NG-RAN node R2 corresponds to the foregoing RAN node 20.

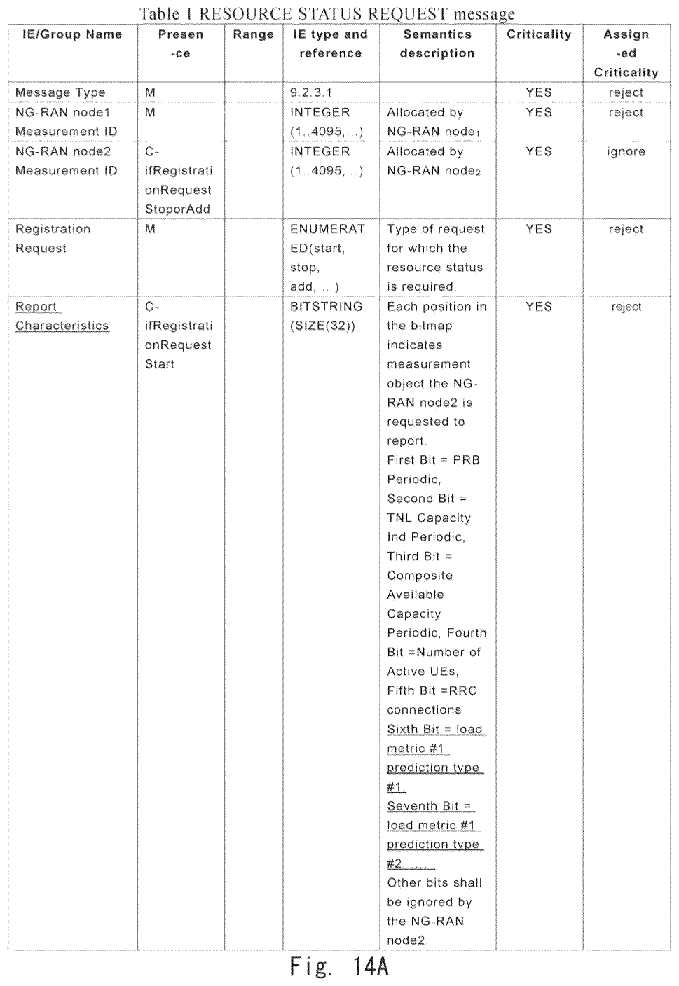

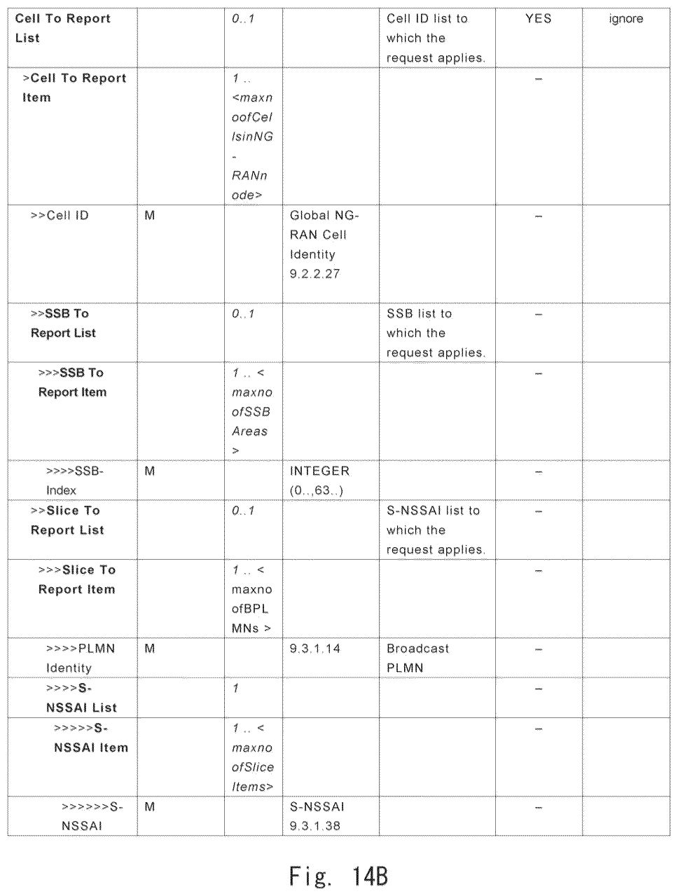

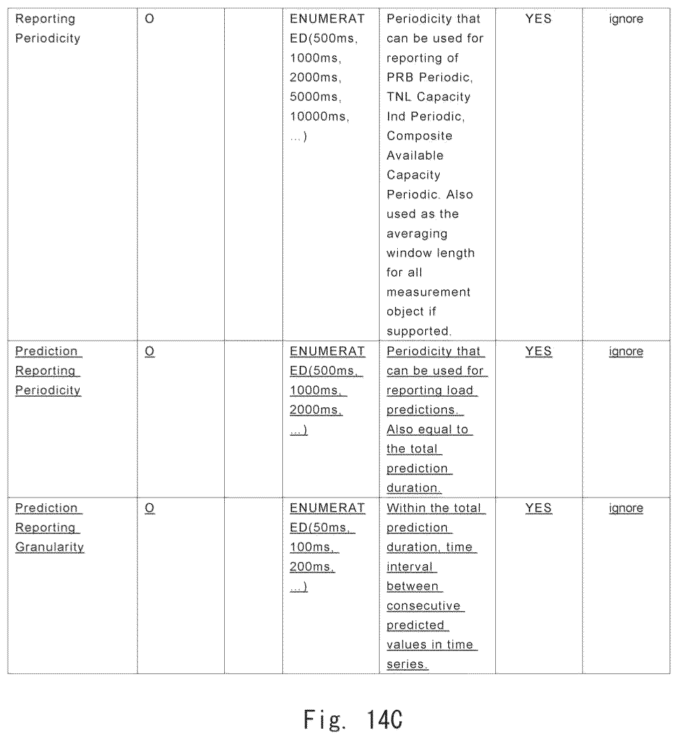

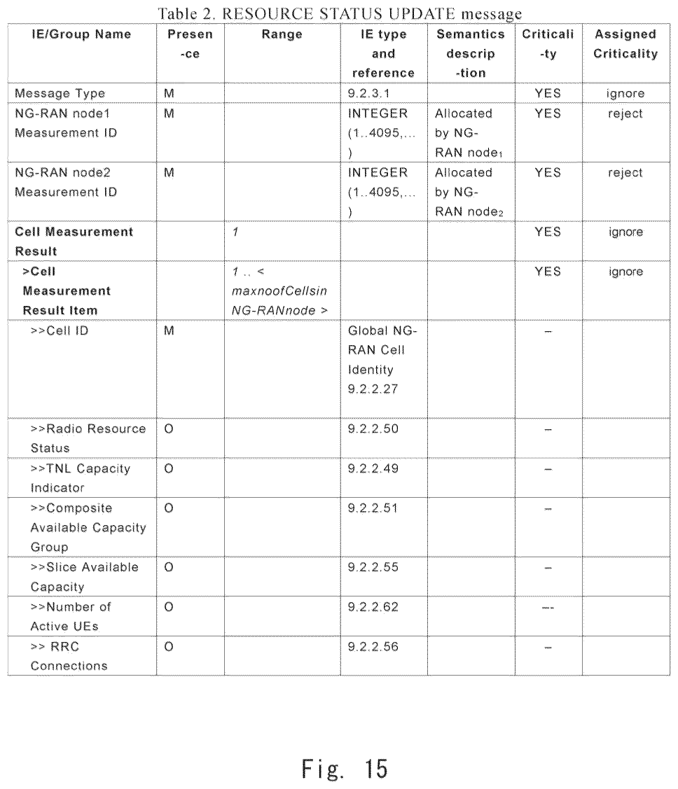

By using the RESOURCE STATUS REQUEST message, the “information related to a prediction value for a load parameter of a cell” may be transmitted from the NG-RAN node R2 to the NG-RAN node R1. The RESOURCE STATUS REQUEST message is defined in section 9.1.3.18 of Non Patent Literature 1. FIGS. 14A to 14C illustrate an example of such a RESOURCE STATUS REQUEST message.

By transmitting this RESOURCE STATUS REQUEST message from the NG-RAN node R1 to the NG-RAN node R2, the transmission of prediction and prediction results regarding the load parameter requested according to the parameter given in the message is started. Then, the value (the value of bits after the 6th bit) of the IE (Report Characteristics IE) underlined in FIG. 14A to 14C indicates the “transmission request for the prediction value”. In FIGS. 14A to 14C, the bits after the 6th bit correspond respectively to different combinations of the load parameter and the prediction type. When this RESOURCE STATUS REQUEST message is transmitted as a step before step S1013, the “information related to a prediction value for a load parameter” is included in the RESOURCE STATUS UPDATE message and transmitted in step S1013. That is, the Report Characteristics IE in FIG. 14A to 14C is used to indicate whether the prediction value corresponding to a certain prediction type of a certain load parameter among the prediction values of the load parameter formed in step S1012 should be reported using the RESOURCE STATUS UPDATE message.

The “load parameter” may include, for example, at least one of the following.
For requested cells, beams, and slices:
At least one of Guaranteed Bit Rate (GBR), non-GBR, or total Physical Resource Block (PRB) usage of at least one of Downlink/Uplink (DL/UL) for each beam of each cell provided by the RAN node 20
At least one of Guaranteed Bit Rate (GBR), non-GBR, or total Physical Resource Block (PRB) usage of at least one of Downlink/Uplink (DL/UL) for each slice of each cell provided by the RAN node 20
For requested cells and beams:

The DL, UL, and SUL capacity including at least one of a capacity of each cell (Per cell capacity) or a capacity for each beam of each cell (Per cell per beam capacity) provided by the RAN node 20.
For requested cells and slices:
a capacity of at least one of Downlink/Uplink (DL/UL) for each slice of each cell provided by the RAN node 20

For example, the “prediction type” may include at least one of the following.
“Prediction for fixed number of UEs”
Average load prediction
Minimum load prediction and maximum load prediction (Minimum and maximum load prediction)
“Prediction for changing number of UEs (Predictions for changing number of UEs)”
Average load prediction
Minimum load prediction and maximum load prediction (Minimum and maximum load prediction)

That is, as described above, each of any combination of the prediction for fixed number of UEs, the prediction for changing number of UEs, an item (average load prediction, minimum load prediction, and maximum load prediction) included in the prediction for fixed number of UEs, and an item (average load prediction, minimum load prediction, and maximum load prediction) included in the prediction for changing number of UEs may be one of “prediction types”.

For example, load metric #1 and prediction type #1 corresponding to the 6th bit of the Report Characteristics IE in FIG. 14A to 14C may correspond to a combination of a “load parameter” that is Guaranteed Bit Rate (GBR), non-GBR, or total Physical Resource Block (PRB) usage of Downlink/Uplink (DL/UL) for each beam of each cell and a “prediction type” that is an average load prediction for a fixed number of UEs.

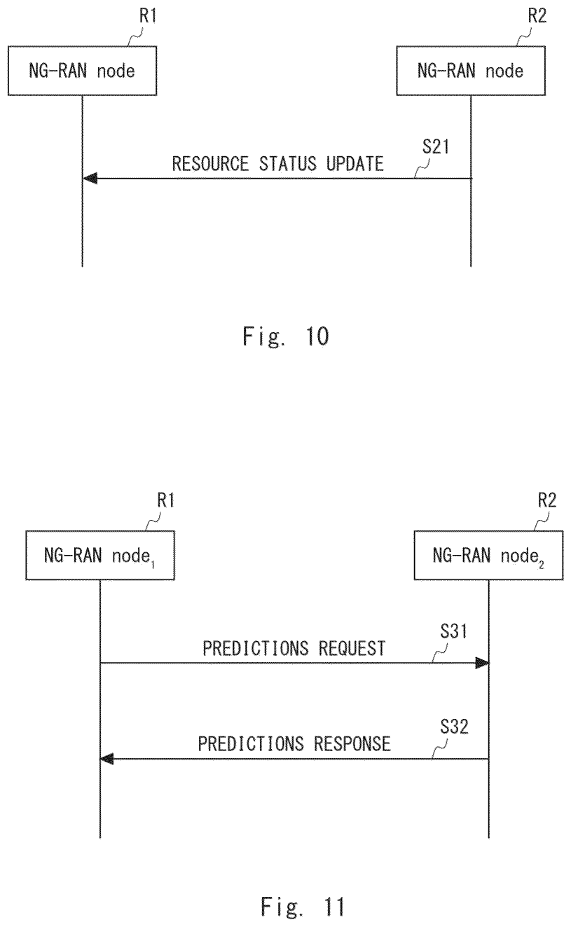

Also, this RESOURCE STATUS REQUEST message may be used to set the “reporting period of the prediction value”, the “prediction granularity”, or both of these. FIG. 9 is a diagram for illustrating another example of the time-series data of information related to the prediction value for the load parameter. In the time-series data illustrated in FIG. 9, the timing information of the data sets adjacent to each other is every 100 milliseconds. That is, the time-series data illustrated in FIG. 9 is reported by setting the value of the “prediction granularity” to a value corresponding to 100 milliseconds in the RESOURCE STATUS REQUEST message. Also, in FIG. 9, the time-series data is transmitted (reported) at the timing of “timing information=0 milliseconds” and the timing of “timing information=2000 milliseconds”. That is, the time-series data illustrated in FIG. 9 is reported by setting a value of “reporting period of the prediction value” to a value corresponding to 2000 milliseconds in the RESOURCE STATUS REQUEST message. Here, the “information related to the prediction value for the load parameter” is included and transmitted in the RESOURCE STATUS UPDATE message. Therefore, the “reporting period of the prediction value” may be equal to the transmitting period of the RESOURCE STATUS UPDATE message including the “information related to the prediction value for the load parameter”. Further, in the example illustrated in FIG. 9, the actual measurement timing for the load parameter is timing 1000 milliseconds before the timing (0 milliseconds) at which the time-series data is transmitted (reported). For example, the time-series data reported at the timing (0 milliseconds) may include a prediction value of the timing included from the actual measurement timing (−1000 milliseconds) to the report timing (+2000 milliseconds) of the next time-series data.

FIG. 10 illustrates a procedure of Resource Status Reporting used to report load information. In response to receiving the RESOURCE STATUS REQUEST message illustrated in FIG. 8, the NG-RAN node R2 starts measurement and prediction requested according to the parameter given in the message, and transmits a RESOURCE STATUS UPDATE message to the NG-RAN node R1 in step S21. This RESOURCE STATUS UPDATE message may include the following information elements: Further, “>” indicates a hierarchy of data:
>Radio Resource Status IE
>Composite Available Capacity Group IE
>Slice Available Capacity IE

The Radio Resource Status IE is used to report, for the requested cells, beams, and slices, the following load parameters.
>DL GBR/DL non-GBR/DL total PRB usage per beam on a cell-by-cell basis (Per cell per beam DL GBR/nonGBR/total PRB usage)
>UL GBR/UL non-GBR/UL total PRB usage per beam on a cell-by-cell basis (Per cell per beam UL GBR/nonGBR/total PRB usage)
>DL GBR/DL non-GBR/DL total PRB usage per slice on a cell-by-cell basis (Per cell per slice DL GBR/nonGBR/total PRB usage)
>UL GBR/UL non-GBR/UL total PRB usage per slice on a cell-by-cell basis (Per cell per slice UL GBR/nonGBR/total PRB usage)

The Composite Available Capacity Group IE is used to report the next load parameter for the requested cells and beams.
>DL, UL, Supplementary UL (SUL) capacity including the following:
>>Capacity on a cell-by-cell basis
>>Capacity of each beam on a cell-by-cell basis

The Slice Available Capacity IE is used to report the next load parameter to the requested cells and slices.
>>DL/UL capacity of each slice on a cell-by-cell basis

After receiving such information from the RAN node R2, the RAN node R1 may start LB HO from the cell of the RAN node R1 to the cell of the RAN node R2 as necessary.

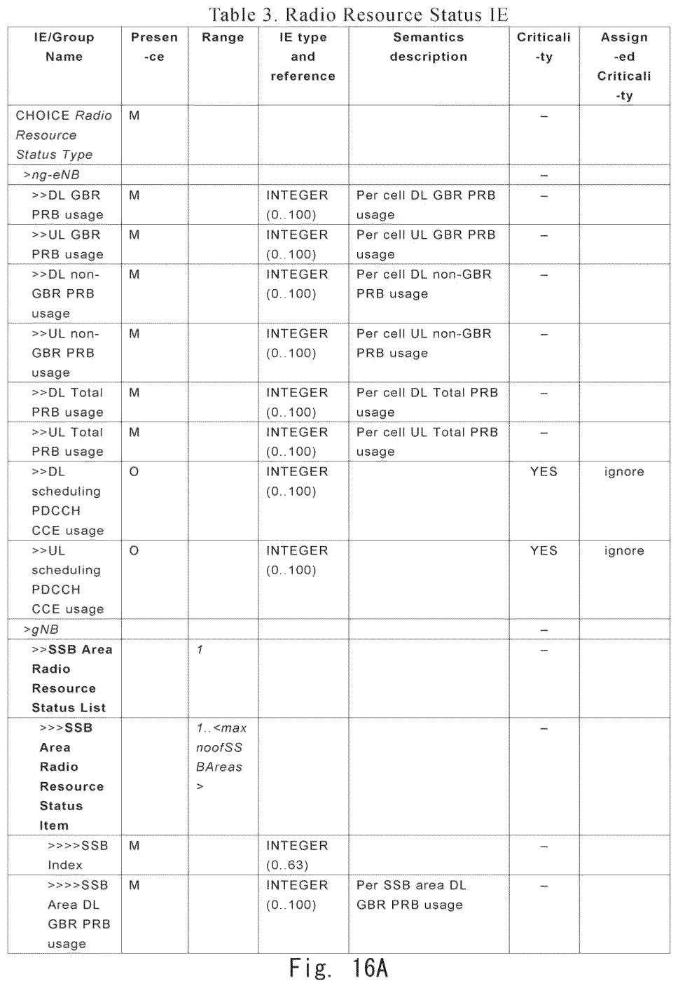

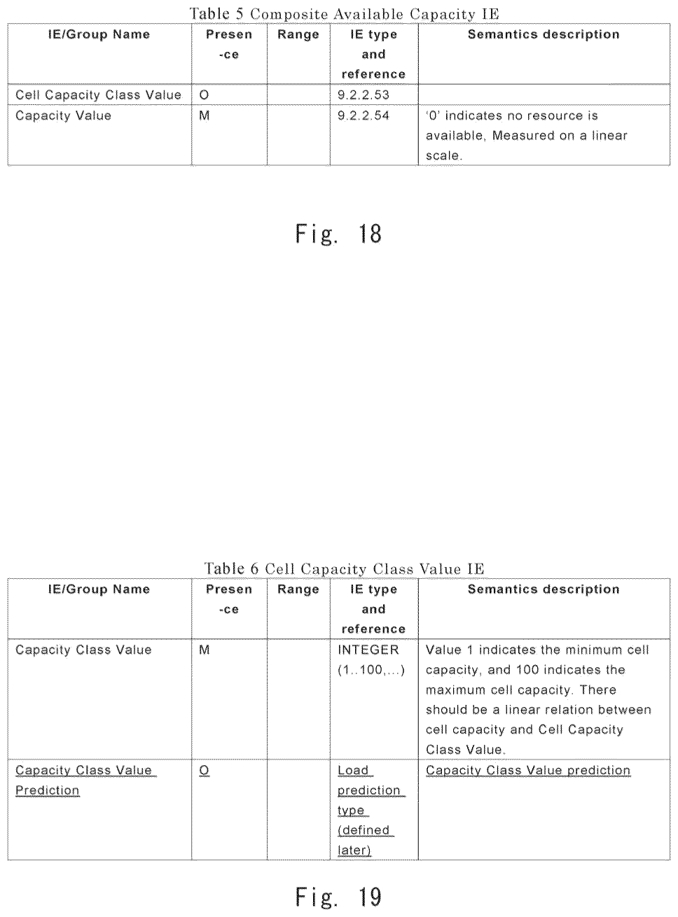

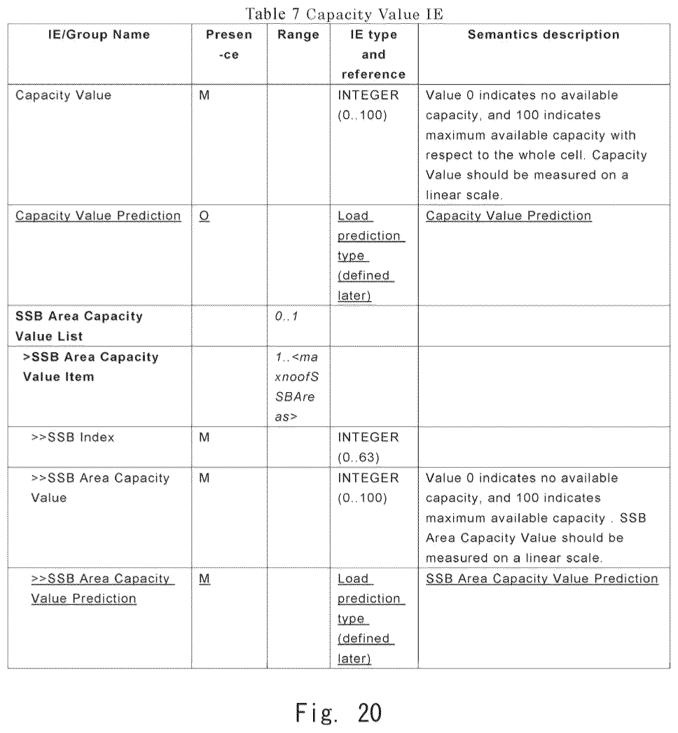

FIGS. 15 to 21 illustrate a specific configuration example of the RESOURCE STATUS UPDATE message. First, as illustrated in FIG. 15, the RESOURCE STATUS UPDATE message, includes:
>Radio Resource Status IE
>Composite Available Capacity Group IE
>Slice Available Capacity IE.

The Radio Resource Status IE is defined in section 9.2.2.50 of Non Patent Literature 1. The Radio Resource Status IE indicates usage situation of PRB in each slice, each Synchronization Signal Block (SSB) area, and each cell for all downlink and uplink traffic, and usage situation of a PDCCH Control Channel Element (CCE) for downlink and uplink scheduling.

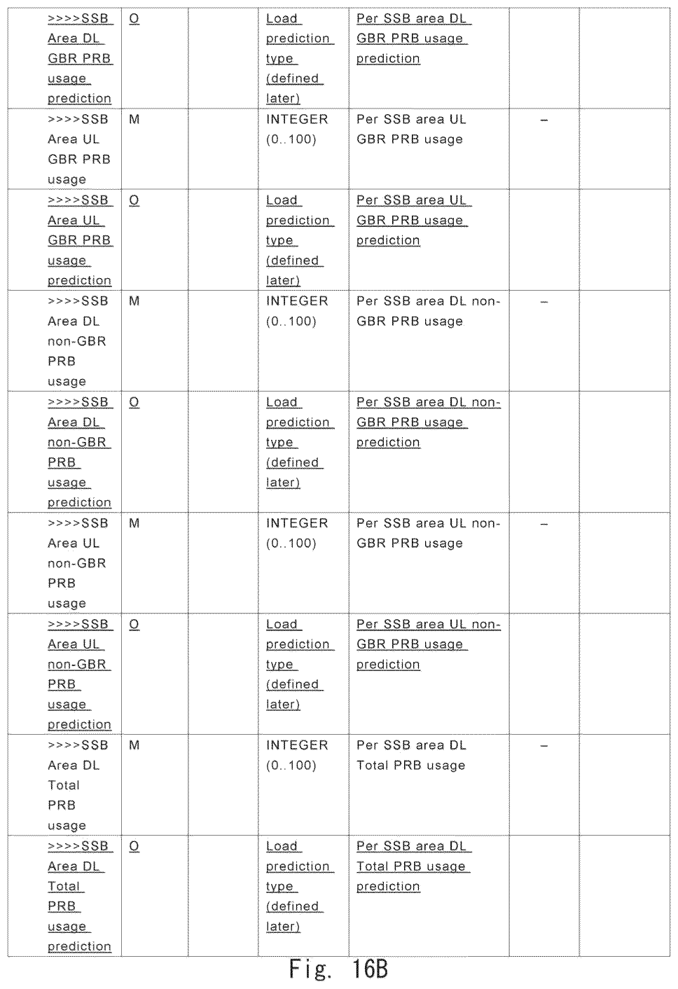

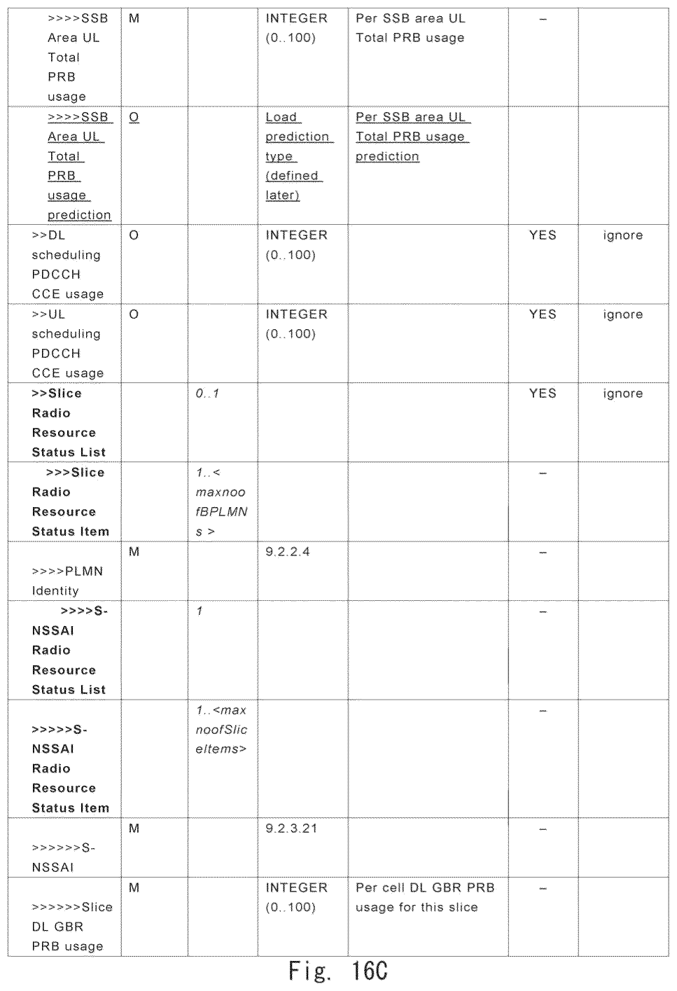

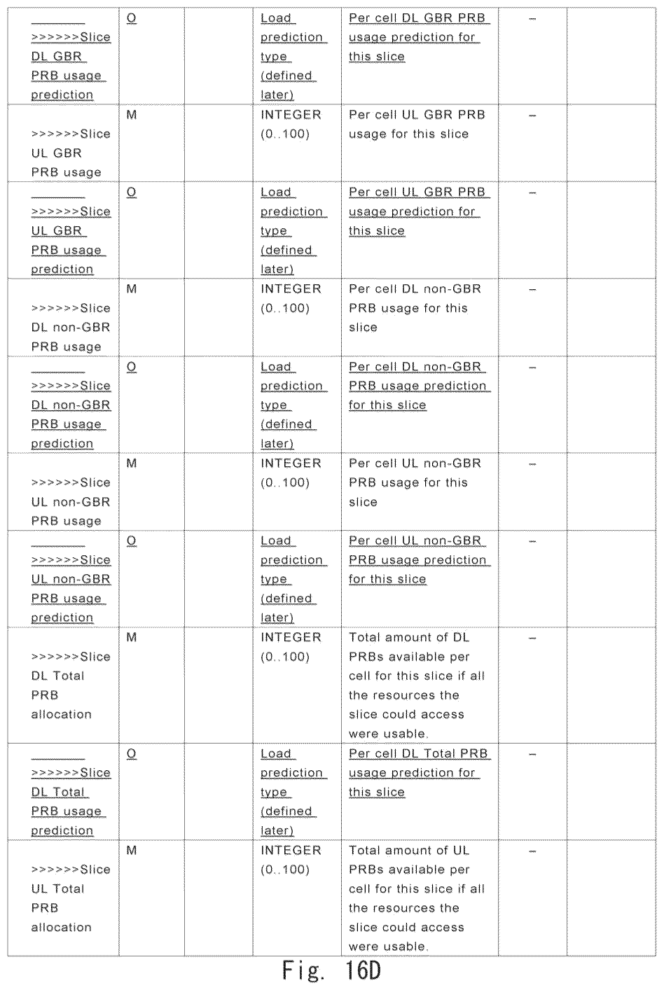

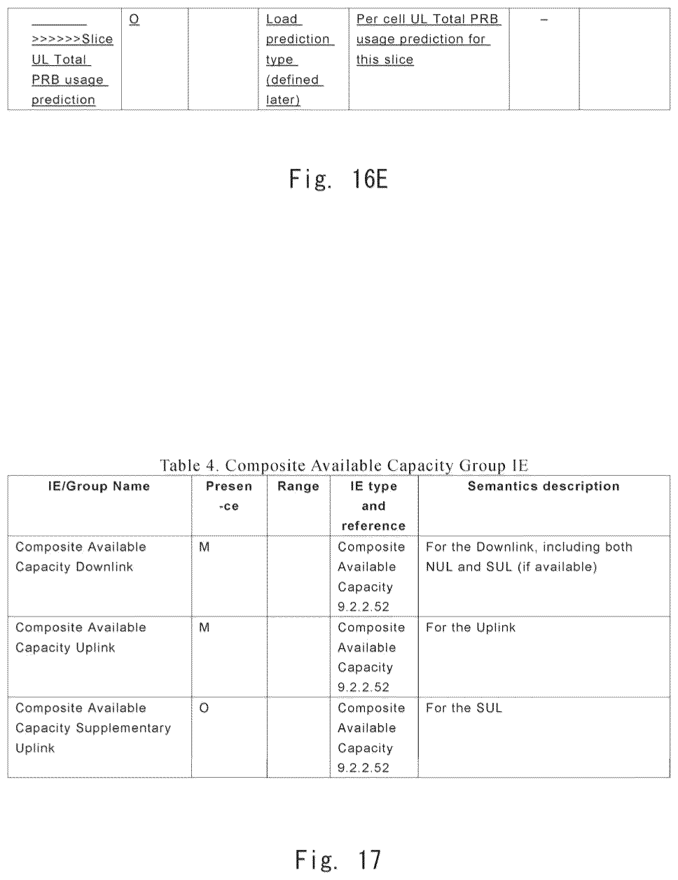

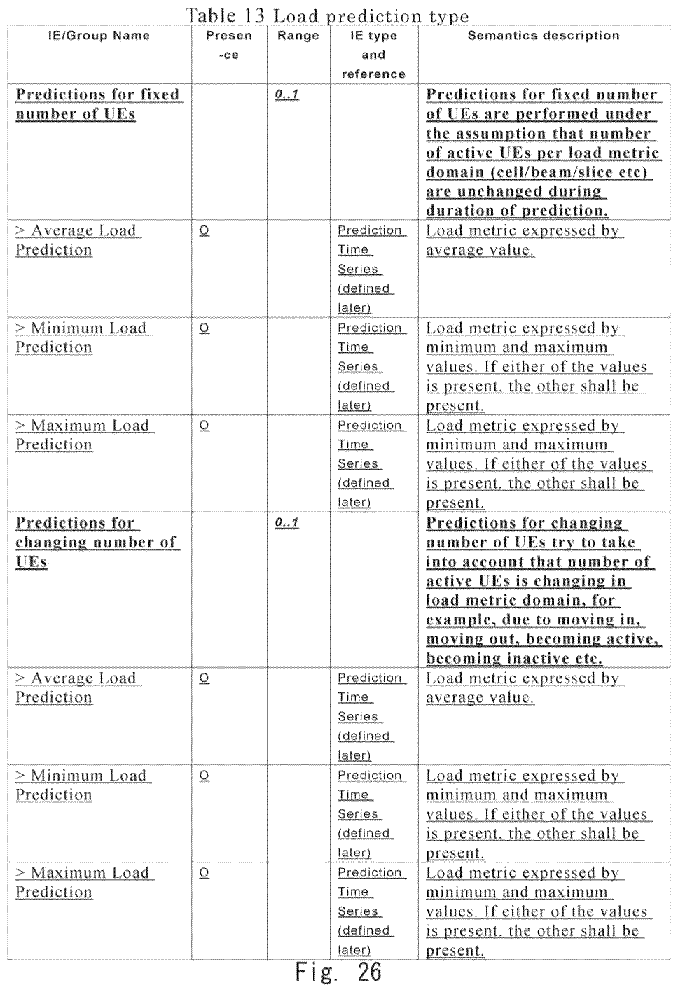

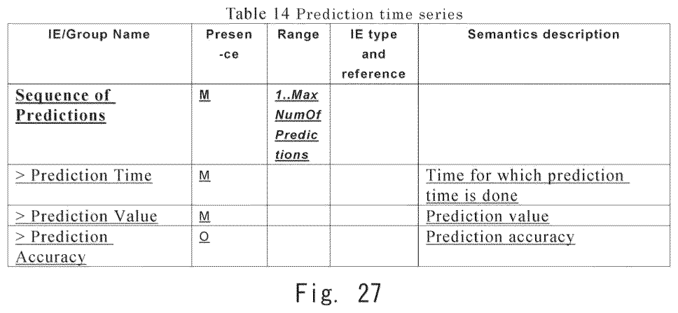

In the present disclosure, the Radio Resource Status IE may be used to report, for the requested cells, beams, and slices, at least one of Guaranteed Bit Rate (GBR), non-GBR, or total Physical Resource Block (PRB) usage of at least one of Downlink/Uplink (DL/UL) for each beam of each cell of each RAN node. Also, in the present disclosure, the Radio Resource Status IE may be used to report, for the requested cells, beams, and slices, at least one of Guaranteed Bit Rate (GBR), non-GBR, or total Physical Resource Block (PRB) usage of at least one of Downlink/Uplink (DL/UL) for each slice of each cell of each RAN node. FIG. 16A to 16E illustrate an example of the implementation of the “information related to the prediction value for the load parameter” of the present disclosure in the Radio Resource Status IE. Each underlined IE in FIGS. 16A to 16E corresponds to “information related to a prediction value for a load parameter” of the present disclosure. Further, the presence of each underlined IE in FIGS. 16A to 16E may be either “O” (optional) or “M” (mandatory). Also, among the IEs underlined in FIG. 16A to 16E, all the IEs do not need to be included in the Radio Resource Status IE, and one or more optional IEs may be included in the Radio Resource Status IE. Also, FIG. 26 illustrates an example of the definition of the prediction type. Also, FIG. 27 illustrates an example of the definition of the time-series data of “information related to a prediction value” included in each underlined IE in FIGS. 16A to 16E.

Also, the Composite Available Capacity Group IE is defined in section 9.2.2.51 of Non Patent Literature 1. In the present disclosure, the Composite Available Capacity Group IE may be used to report, for the requested cells and beams, the DL, UL, and a Supplementary UL (SUL) capacity (capacity) including at least one of a capacity of each cell (Per cell capacity) or a capacity for each beam of each cell (Per cell per beam capacity) of each RAN node. FIGS. 17 to 20 illustrate examples of the implementation of the “information related to the prediction value for the load parameter” of the present disclosure in the Composite Available Capacity Group IE. Each underlined IE in FIGS. 17 to 20 corresponds to “information related to a prediction value for a load parameter” of the present disclosure. Further, the presence of each IE underlined in FIGS. 17 to 20 may be either “O” (optional) or “M” (mandatory). Also, among the IEs underlined in FIGS. 17 to 20, all the IEs do not need to be included in the Composite Available Capacity Group IE, and one or more optional IEs may be included in the Composite Available Capacity Group IE. Also, FIG. 26 illustrates an example of the definition of the prediction type. Also, FIG. 27 illustrates an example of the definition of the time-series data of “information related to the prediction value” included in each IE indicated by an underline in FIGS. 17 to 20.

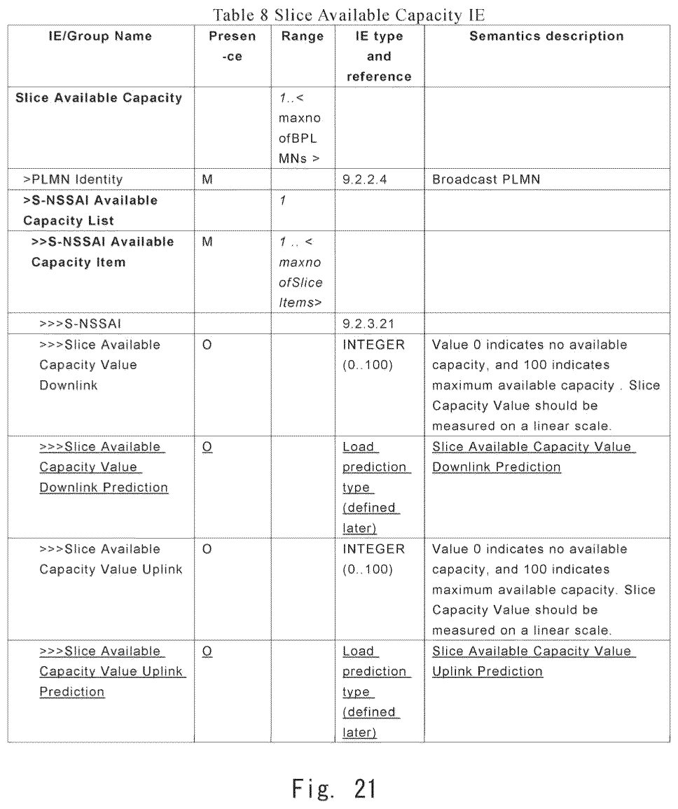

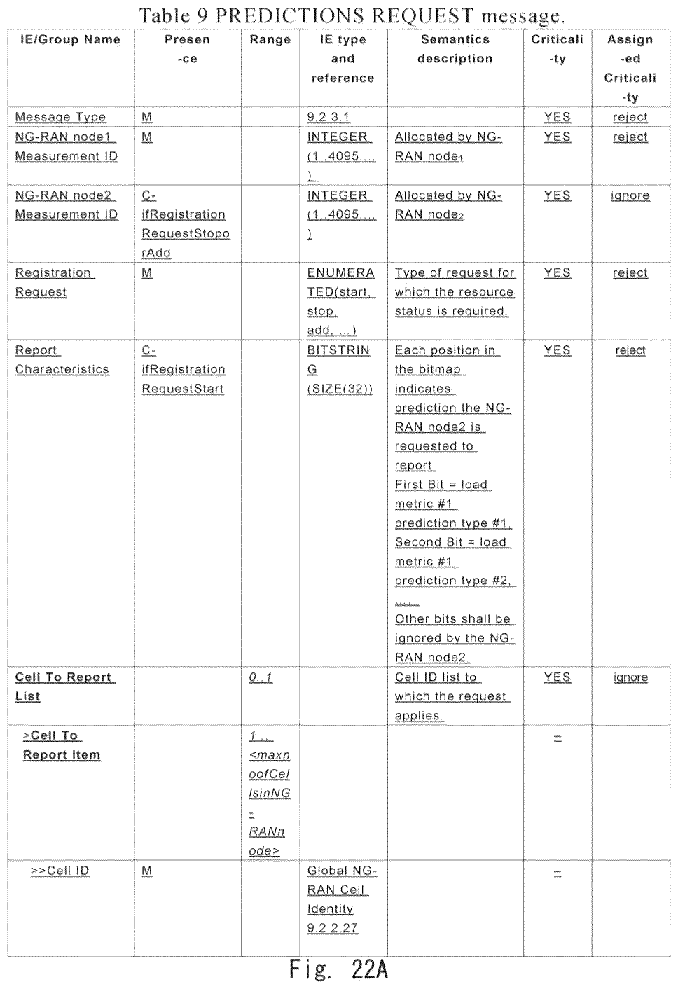

The Slice Available Capacity IE is defined in section 9.2.2.55 of Non Patent Literature 1. In the present disclosure, the Slice Available Capacity IE may be used to report a capacity (capacity) of at least one of Downlink/UPlink (DL/UL) for each slice of each PLMN of each cell for the requested cells and slices. FIG. 21 illustrates an example of the implementation of the “information related to the prediction value for the load parameter” of the present disclosure in the Slice Available Capacity IE. Each IE underlined in FIG. 21 corresponds to the “information related to the prediction value for a load parameter” of the present disclosure. Further, the presence of each IE underlined in FIG. 21 may be “O” either (optional) or “M” (mandatory). Also, among the IEs underlined in FIG. 21, all the IEs do not need to be included in the Composite Available Capacity Group IE, and one or more optional IEs may be included in the Composite Available Capacity Group IE. Also, FIG. 26 illustrates an example of the definition of the prediction type. Also, FIG. 27 illustrates an example of the definition of the time-series data of the “information related to the prediction value” included in each IE underlined in FIG. 21.

### (B) Use Of New Procedure

Here, a procedure specialized for the setting of the report of the prediction value and the report of the prediction value is proposed. This procedure may be used not only for setting and reporting of “information related to a prediction value for a load parameter”, but also for setting and reporting of other prediction values.

FIG. 11 illustrates PREDICTIONS Reporting Initiation procedure used in order to request other NG-RAN nodes to report information related to the prediction value for the load parameter. This procedure may be used to transmit the second message described in the second example embodiment. In step S31 of FIG. 11, the NG-RAN node R1 transmits the PREDICTIONS REQUEST message to the NG-RAN node R2. The NG-RAN node R1 corresponds to the foregoing RAN node 30, and the NG-RAN node R2 corresponds to the foregoing RAN node 20.

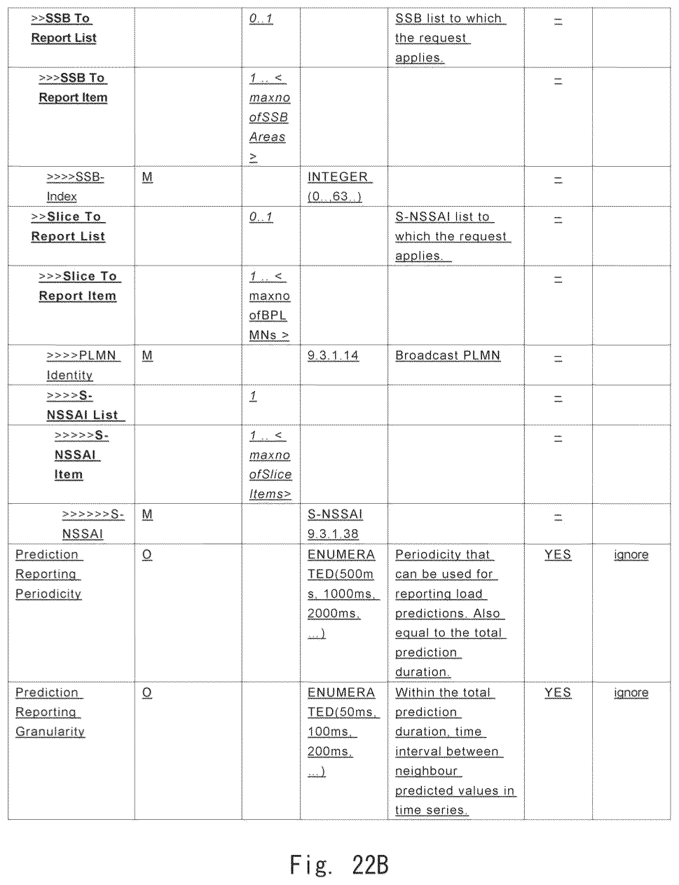

By using the PREDICTIONS REQUEST message, the “information related to the prediction value for the load parameter of the cell” transmitted from the NG-RAN node R2 may be set. FIGS. 22A and 22B illustrate the PREDICTIONS REQUEST message.

By transmitting this PREDICTIONS REQUEST message from the NG-RAN node R1 to the NG-RAN node R2, the transmission of prediction and prediction results regarding the load parameter requested according to the parameter given in the message is started. Then, the value (the value of each bit) of Report Characteristics IE in FIGS. 22A and 22B indicates the “transmission request for the prediction value”. In FIGS. 22A and 22B, each bit corresponds to any of different combinations of the load parameter and the prediction type. When this PREDICTIONS REQUEST message is transmitted as a step before step S1013, the “information related to the prediction value for the load parameter” is included in the PREDICTIONS UPDATE message and transmitted in step S1013. That is, the Report Characteristics IE in FIGS. 22A and 22B are used to indicate whether the prediction value corresponding to a certain prediction type of a certain load parameter among the prediction values of the load parameter formed in step S1012 should be reported using the PREDICTIONS UPDATE message.

The description of the “load parameter”, the “prediction type”, the “reporting period of the prediction value”, and the “prediction granularity” has been made in the Resource Status Reporting procedure, and thus, will be omitted here.

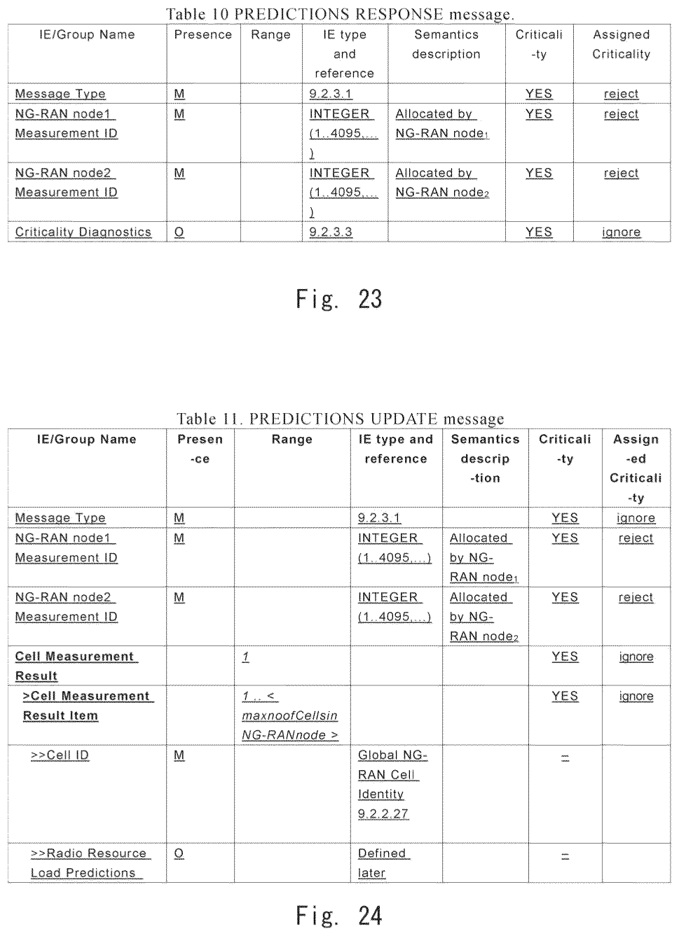

In step S32 of FIG. 11, the NG-RAN node R2 transmits the PREDICTIONS RESPONSE message to the NG-RAN node R1. FIG. 23 illustrates the PREDICTIONS RESPONSE message.

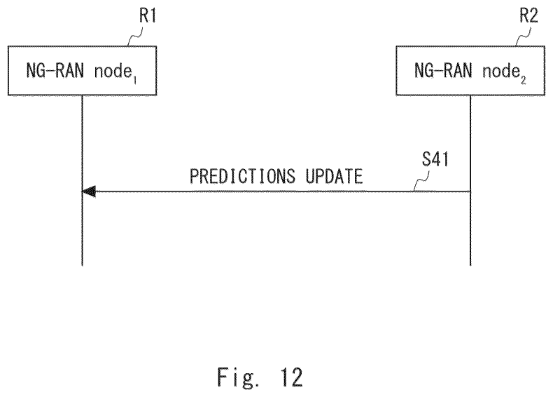

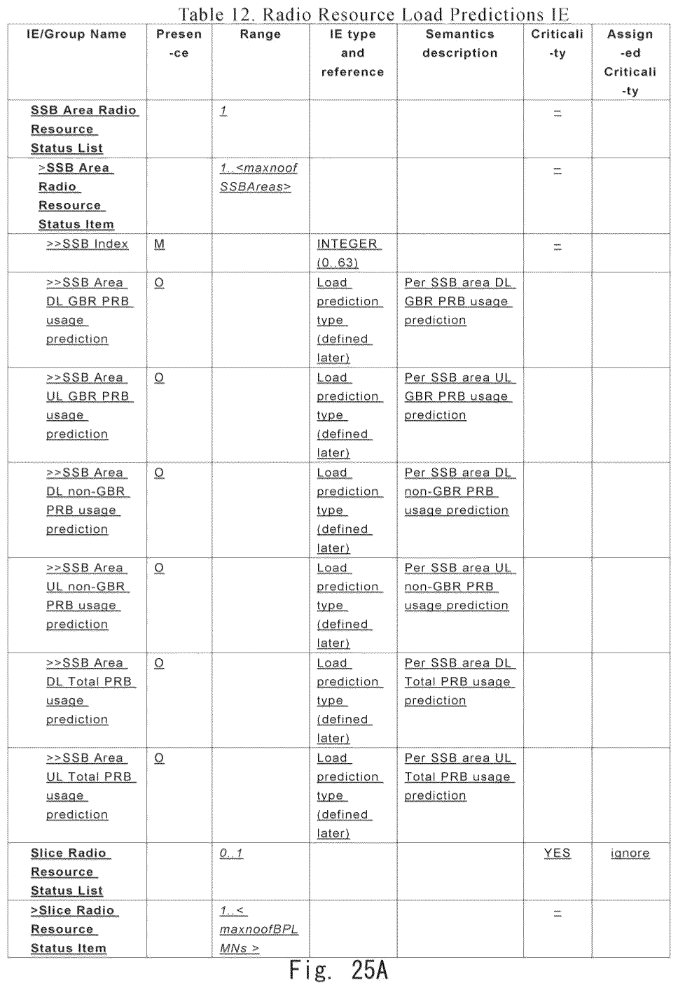

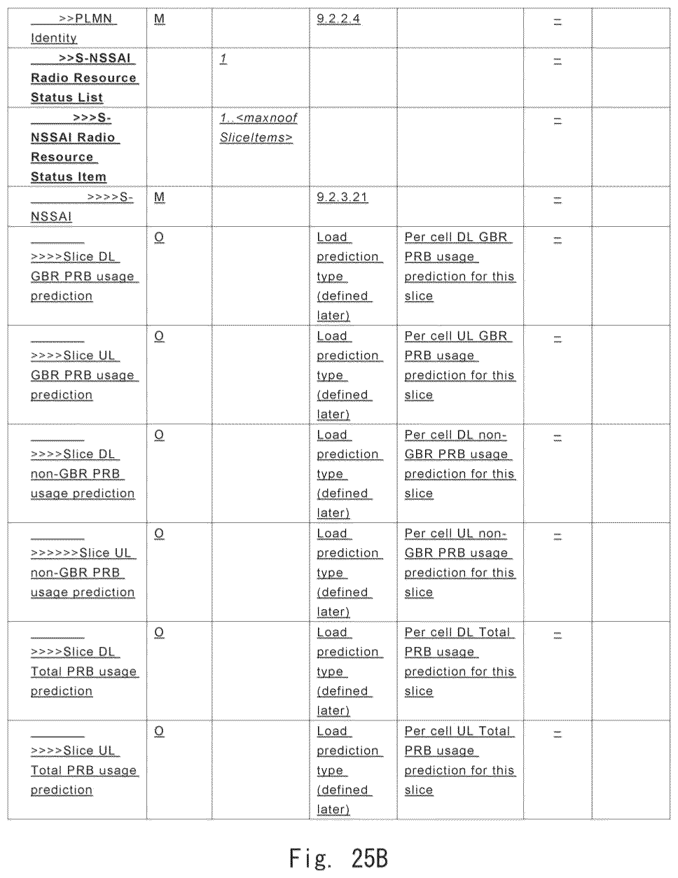

FIG. 12 illustrates PREDICTIONS Reporting procedure used to report information related to the prediction value for the load parameter. In response to receiving the PREDICTIONS REQUEST message illustrated in FIG. 11, the NG-RAN node R2 starts measurement and prediction requested according to the parameter given in the message, and transmits PREDICTIONS UPDATE message to the NG-RAN node R1 in step 41. FIG. 24 illustrates the PREDICTIONS UPDATE message. This PREDICTIONS UPDATE message may include a “Radio Resource Load Predictions IE”. This “Radio Resource Load Predictions IE” may include the “information related to the prediction value for the load parameter” illustrated in FIGS. 15 to 21. FIGS. 25A and 25B illustrate an example of configuration of Radio Resource Load Predictions IE. In FIGS. 25A and 25B, all the “information related to the prediction value for the load parameter” illustrated in FIGS. 15 to 21 are not illustrated, and a part thereof is omitted. Also, the PREDICTIONS UPDATE message may include other Predictions IEs, and the other Predictions IEs may include information related to other prediction values (for example, information related to the prediction value for the UE trajectory, and the like).

FIG. 26 illustrates the prediction type that may be included in each IE related to the prediction value for the load parameter. Each IE related to the prediction value for the load parameter may have the following configuration as illustrated in FIG. 26. Further, “>” indicates a hierarchy of data:
>“Predictions for fixed number of UEs”
>>Average load prediction
>>Minimum load prediction
>>Maximum load prediction
>“Predictions for changing number of UEs”
>>Average load prediction
>>Minimum load prediction
>>Maximum load prediction

FIG. 27 illustrates an example of configuration of the time-series data of information related to the prediction value. The time-series data may have the following configuration as illustrated in FIG. 27. Further, “>” indicates a hierarchy of data:
>Sequence of Predictions
>>Timing information (Prediction Time)
>>Prediction Value
>>Prediction Accuracy

As the Prediction Value, a plurality of candidate values may be presented. The plurality of candidate values is defined by, for example, a bit string. For example, a Prediction Value may be encoded into an integer (0 to 100). For example, 0 corresponds to 0% load and 100 corresponds to 100% load.

As the Prediction Accuracy, a plurality of candidate values may be presented. The plurality of candidate values is defined by, for example, a bit string.

For example, the Prediction Accuracy may be encoded into an integer (0 to 100). For example, 0 corresponds to accuracy 0 (completely inaccurate) and 100 corresponds to accuracy 1 (completely accurate).

Also, for example, the Prediction Accuracy may be encoded as follows.
Very accurate=value greater than 0.95 or less than or equal to 1
High accuracy=value greater than 0.9 and less than or equal to 0.95
Quite accurate=value greater than 0.75 and less than or equal to 0.9
Incorrect=value less than or equal to 0.75

### (Step S1014)

The RAN node 30 receives a “first message” including “information related to a prediction value for a load parameter of a cell”. Also, the RAN node 30 may receive load-related information from other near RAN nodes having no AI/ML. The RAN node 30 may use load-related information acquired from such a nearby RAN node for load balancing determination (for example, determination of load balancing handover).

### Other Example Embodiments

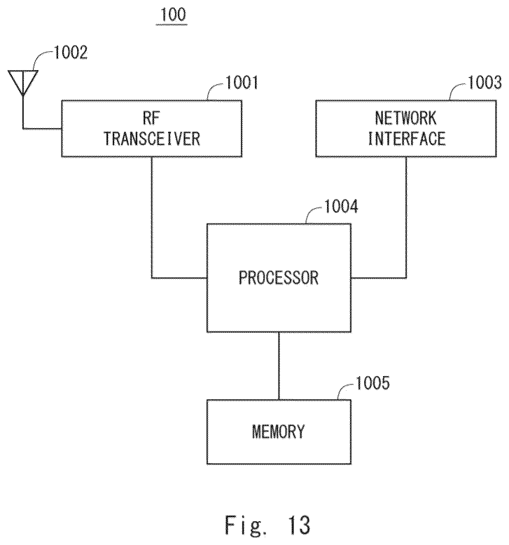

Examples of configuration of the Hardware components of the RAN node 100 described in the plurality of example embodiments as described above will be described. FIG. 13 is a block diagram for illustrating an example of configuration of a RAN node according to each example embodiment. Referring to FIG. 13, the RAN node 100 includes a Radio Frequency (RF) transceiver 1001, a network interface 1003, a processor 1004, and a memory 1005. The RF transceiver 1001 performs analog RF signal processing to communicate with the UE. The RF transceiver 1001 may include a plurality of transceivers. The RF transceiver 1001 is coupled with the antenna 1002 and the processor 1004. The RF transceiver 1001 receives the modulation symbol data (or Orthogonal Frequency Division Multiplexing (OFDM) symbol data) from the processor 1004, generates a transmission RF signal, and provides the transmission RF signal to the antenna 1002. Also, the RF transceiver 1001 generates a baseband reception signal based on the reception RF signal received by the antenna 1002, and provides the baseband reception signal to the processor 1004.

The network interface 1003 is used to communicate with a network node (for example, other core network). The network interface 1003 may include, for example, a network interface card (NIC) conforming to Institute of Electrical and Electronics Engineers (IEEE) 802.3 series.

The processor 1004 performs data plane processing including digital baseband signal processing for wireless communication and control plane processing. For example, for LTE and 5G, the digital baseband signal processing by the processor 1004 may include signal processing of the MAC layer and the Physical layer.

The processor 1004 may include a plurality of processors. For example, the processor 1004 may include a modem processor (e.g., a Digital Signal Processor (DSP)) that performs digital baseband signal processing and a protocol stack processor (e.g., a Central Processing Unit (CPU) or a Micro Processor Unit (MPU)) that performs control plane processing.

The memory 1005 is configured by a combination of a volatile memory and a nonvolatile memory. The memory 1005 may include a plurality of physically independent memory devices. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 1005 may include a storage disposed away from the processor 1004. In this case, the processor 1004 may access the memory 1005 through a network interface 1003 or an I/O interface that is not illustrated.

The memory 1005 may store a software module (computer program) including a group of instructions and data for performing processing by the RAN node 100 described in example embodiments as described above. In some implementations, the processor 1004 may be configured to perform the processing of the RAN node 100 described in the example embodiments as described above by reading the software module from the memory 1005 and executing it.

As described above, one or more of processors included in each apparatus of the example embodiments as described above execute one or more of programs including a group of instructions for causing a computer to execute an algorithm described with reference to the drawings. By this processing, the signal processing method described in each example embodiment may be implemented.

The program includes a group of instructions (or software code) for causing the computer to perform one or more functions described in the example embodiments when the program is loaded into the computer. The program may be stored in a non-transitory computer-readable medium or a tangible storage medium. By way of example, and not limitation, the non-transitory computer-readable medium or the tangible storage medium includes random-access memory (RAM), read-only memory (ROM), flash memory, solid-state drive (SSD) or any other memory technology, CD-ROM, digital versatile disk (DVD), Blu-ray (registered trademark) disc or any other optical disk storage, magnetic cassette, magnetic tape, magnetic disk storage, and any other magnetic storage device. The program may be transmitted on a transitory computer-readable medium or a communications medium. By way of example, and not limitation, transitory computer-readable or communication media include electrical, optical, acoustic, or other forms of propagated signals.

In the present specification, a user equipment (UE) (alternatively, including a mobile station, a mobile terminal, a mobile device, a wireless device, or the like) is an entity connected to a network through a wireless interface.

Some or all of the above-described example embodiments may be described as in the following supplementary notes, but are not limited to the following supplementary notes.

### (Supplementary Note 1)

A radio access network (RAN) node, including:
a memory;
a processor coupled to the memory; and
a transceiver, wherein
the processor is configured so as to cause the transceiver to transmit a first message to other RAN nodes, and
the first message includes information related to a prediction value for a parameter regarding a load of a cell of the RAN node.

### (Supplementary Note 2)

The RAN node according to supplementary note 1, wherein information related to the prediction value includes the prediction value at each of a plurality of timings.

### (Supplementary Note 3)

The RAN node according to supplementary note 1 or 2, wherein information related to the prediction value includes the prediction value at a timing after a transmission timing of the first message.

### (Supplementary Note 4)

The RAN node according to any one of supplementary notes 1 to 3, wherein information related to the prediction value includes the prediction value and prediction accuracy of the prediction value.

### (Supplementary Note 5)

The RAN node according to any one of supplementary notes 1 to 4, wherein
information related to the prediction value includes a plurality of sets, and
each of the sets includes timing information, the prediction value, and prediction accuracy of the prediction value.

### (Supplementary Note 6)

The RAN node according to any one of supplementary notes 1 to 5, wherein information related to the prediction value includes:
a prediction value under assumption that the number of active user equipments (UEs) in a domain related to a parameter regarding the load of the cell is unchanged during a prediction period;
a prediction value under consideration that the number of active UEs in a domain related to a parameter regarding the load of the cell is changed during a prediction period; or
both of them.

### (Supplementary Note 7)

The RAN node according to any one of supplementary notes 1 to 6, wherein information related to the prediction value includes the prediction value for each uplink and each downlink in the cell.

### (Supplementary Note 8)

The RAN node according to any one of supplementary notes 1 to 7, wherein information related to the prediction value includes the prediction value in a slice of the cell.

### (Supplementary Note 9)

The RAN node according to any one of supplementary notes 1 to 8, wherein the processor is configured so as to cause the transceiver to receive a second message transmitted from the other RAN nodes, and the second message includes information about a transmission request for information related to the prediction value.

### (Supplementary Note 10)

The RAN node according to supplementary note 9, wherein the second message further includes information about a reporting period of the prediction value.

### (Supplementary Note 11)

The RAN node according to supplementary note 9 or 10, wherein the second message further includes information about a prediction granularity related to a timing interval of the prediction value.

### (Supplementary Note 12)

The RAN node according to any one of supplementary notes 1 to 11, wherein the first message is a RESOURCE STATUS REQUEST message.

### (Supplementary Note 13)

The RAN node according to any one of supplementary notes 9 to 11, wherein the second message is a RESOURCE STATUS UPDATE message.

### (Supplementary Note 14)

A radio access network (RAN) node, including:
a memory;
a processor coupled to the memory; and
a transceiver, wherein
the processor is configured so as to cause the transceiver to receive a first message transmitted from another RAN node, and
the first message includes information about a prediction value for a parameter regarding a load of a cell of the other RAN node.

### (Supplementary Note 15)

The RAN node according to supplementary note 14, wherein information related to the prediction value includes the prediction value at each of a plurality of timings.

### (Supplementary Note 16)

The RAN node according to supplementary note 14 or 15, wherein information related to the prediction value includes the prediction value at a timing after a transmission timing of the first message.

### (Supplementary Note 17)

The RAN node according to any one of supplementary notes 14 to 16, wherein information related to the prediction value includes the prediction value and prediction accuracy of the prediction value.

### (Supplementary Note 18)

The RAN node according to any one of supplementary notes 14 to 17, wherein
information related to the prediction value includes a plurality of sets, and
each of the sets includes timing information, the prediction value, and prediction accuracy of the prediction value.

### (Supplementary Note 19)

The RAN node according to any one of supplementary notes 14 to 18, wherein information related to the prediction value includes:
a prediction value under assumption that the number of active user equipments (UEs) in a domain related to a parameter regarding the load of the cell is unchanged during a prediction period;
a prediction value under consideration that the number of active UEs in a domain related to a parameter regarding the load of the cell is changed during a prediction period; or
both of them.

### (Supplementary Note 20)

The RAN node according to any one of supplementary notes 14 to 19, wherein information related to the prediction value includes the prediction value for each uplink and each downlink in the cell.

### (Supplementary Note 21)

The RAN node according to any one of supplementary notes 14 to 20, wherein information related to the prediction value includes the prediction value in a slice of the cell.

### (Supplementary Note 22)

The RAN node according to any one of supplementary notes 14 to 21, wherein the processor is configured so as to cause the transceiver to transmit a second message to the other RAN nodes, and the second message includes information about a transmission request for information related to the prediction value.

### (Supplementary Note 23)

The RAN node according to supplementary note 22, wherein the second message further includes information about a reporting period of the prediction value.

### (Supplementary Note 24)

The RAN node according to supplementary note 22 or 23, wherein the second message further includes information about a prediction granularity related to a timing interval of the prediction value.

### (Supplementary Note 25)

The RAN node according to any one of supplementary notes 14 to 24, wherein the first message is a RESOURCE STATUS UPDATE message.

### (Supplementary Note 26)

The RAN node according to any one of supplementary notes 22 to 24, wherein the second message is a RESOURCE STATUS REQUEST message.

### (Supplementary Note 27)

A method performed by a radio access network (RAN) node, including transmitting a first message to other RAN nodes,
wherein the first message includes information related to a prediction value for a parameter regarding a load of a cell of the RAN node.

### (Supplementary Note 28)

The method according to supplementary note 27, wherein the information includes the prediction value at each of a plurality of timings.

### (Supplementary Note 29)

A method performed by a radio access network (RAN) node, including receiving a first message transmitted from another RAN node,
wherein the first message includes information related to a prediction value for a parameter regarding a load of a cell of the other RAN node.

### (Supplementary Note 30)

The method according to supplementary note 29, wherein the information includes the prediction value at each of a plurality of timings.

### (Supplementary Note 31)

A program causing a radio access network (RAN) node to execute a process, the process including transmitting a first message to other RAN nodes,
wherein the first message includes information related to a prediction value for a parameter regarding a load of a cell of the RAN node.

### (Supplementary Note 32)

The program according to supplementary note 31, wherein the information includes the prediction value at each of a plurality of timings.

### (Supplementary Note 33)

A program causing a radio access network (RAN) node to execute a process, the process including receiving a first message transmitted from another RAN node,
wherein the first message includes information related to a prediction value for a parameter regarding a load of a cell of the RAN node.

### (Supplementary Note 34)

The program according to supplementary note 33, wherein the information includes the prediction value at each of a plurality of timings.

Although the present disclosure has been described above with reference to the example embodiments, the present disclosure is not limited to the above. Various modifications that could be understood by those skilled in the art may be made to the configuration and details of the present disclosure within the scope of the disclosure.

This application claims priority based on Japanese Patent Application No. 2022-035279 filed on Mar. 8, 2022, the entire disclosure of which is incorporated herein.

### REFERENCE SIGNS LIST

1, 10 COMMUNICATION SYSTEM
2, 3, 20, 30, 100, R1, R2 RAN NODE
4-1, 4-2, 41, 42, 43, 44, 45, 46 CELL
51 UE
101 COMMUNICATION UNIT
102 CONTROL UNIT

What is claimed is:

1-30. (canceled)

31. A method of a first Radio Access Network (RAN) node, the method comprising:
receiving a first message from a second RAN node, wherein the first message includes a first information element, and wherein the first information element indicates a type of object on which the first RAN node performs a prediction;
performing the prediction to generate predicted information, wherein the predicted information includes usage of Physical Resource Blocks (PRBs) per Synchronization Signal Block (SSB) for traffic in Downlink and Uplink; and
sending a second message to the second RAN node, wherein the second message includes the predicted information.

32. The method according to claim 31,
wherein the first message includes a second information element, and
wherein the second information element indicates a point in time to which the prediction applies.

33. The method according to claim 31,
wherein the predicted information is related to a predicted number of active User Equipments (UEs).

34. The method according to claim 31,
wherein the predicted information includes SSB Area Downlink (DL) Guaranteed Bitrate (GBR) Physical Resource Block (PRB) usage, SSB Area Uplink (UL) GBR PRB usage, SSB Area DL non-GBR PRB usage, SSB Area UL non-GBR PRB usage, SSB Area DL Total PRB usage, and SSB Area UL Total PRB usage.

35. The method according to claim 31,
wherein the first information element is a Report Characteristics.

36. The method according to claim 31,
wherein the predicted information is a Radio Resource Status.

37. The method according to claim 32,
wherein the second information element is a Prediction Time.

38. The method according to claim 31,
wherein the first RAN node is a Next Generation RAN (NG-RAN) node,
wherein the second RAN node is an NG-RAN node,
wherein the first message is an Xn message, and
wherein the second message is an Xn message.

39. A first Radio Access Network (RAN) node comprising:
a memory; and
a processor coupled with the memory, wherein the memory is configured to:
receive a first message from a second RAN node, wherein the first message includes a first information element, and wherein the first information element indicates a type of object on which the first RAN node performs a prediction,
perform the prediction to generate predicted information, wherein the predicted information includes usage of Physical Resource Blocks (PRBs) per Synchronization Signal Block (SSB) for traffic in Downlink and Uplink, and
send a second message to the second RAN node, wherein the second message includes the predicted information.

40. The first RAN node according to claim 39,
wherein the first message includes a second information element, and
wherein the second information element indicates a point in time to which the prediction applies.

41. The first RAN node according to claim 39,
wherein the predicted information is related to a predicted number of active User Equipments (UEs).

42. The first RAN node according to claim 39,
wherein the predicted information includes SSB Area Downlink (DL) Guaranteed Bitrate (GBR) Physical Resource Block (PRB) usage, SSB Area Uplink (UL) GBR PRB usage, SSB Area DL non-GBR PRB usage, SSB Area UL non-GBR PRB usage, SSB Area DL Total PRB usage, and SSB Area UL Total PRB usage.

43. The first RAN node according to claim 39,
wherein the first information element is a Report Characteristics.

44. The first RAN node according to claim 39,
wherein the predicted information is a Radio Resource Status.

45. The first RAN node according to claim 40,
wherein the second information element is a Prediction Time.

46. The first RAN node according to claim 39,
wherein the first RAN node is a Next Generation RAN (NG-RAN) node,
wherein the second RAN node is an NG-RAN node,
wherein the first message is an Xn message, and
wherein the second message is an Xn message.

47. A method of a User Equipment (UE), the method comprising:
communicating with a first Radio Access Network (RAN) node,
wherein the first RAN node is configured to:
receive a first message from a second RAN node, wherein the first message includes a first information element, and wherein the first information element indicates a type of object on which the first RAN node performs a prediction,
perform the prediction to generate predicted information, wherein the predicted information includes usage of Physical Resource Blocks (PRBs) per Synchronization Signal Block (SSB) for traffic in Downlink and Uplink, and
send a second message to the second RAN node, wherein the second message includes the predicted information.

48. A User Equipment (UE) comprising:
a memory; and
a processor coupled with the memory, wherein the processor is configured to:
communicate with a first Radio Access Network (RAN) node,
wherein the first RAN node is configured to:
receive a first message from a second RAN node, wherein the first message includes a first information element, and wherein the first information element indicates a type of object on which the first RAN node performs a prediction,
perform the prediction to generate predicted information, wherein the predicted information includes usage of Physical Resource Blocks (PRBs) per Synchronization Signal Block (SSB) for traffic in Downlink and Uplink, and
send a second message to the second RAN node, wherein the second message includes the predicted information.
